(19) United States
(12) Patent Application Publication
(10) Pub. No.: US 2026/0270016 A1
(43) Pub. Date: Sep. 10, 2026

(54) ENCODING SCHEMES FOR WIRE-LESS COMMUNICATIONS SYSTEMS THAT SUPPORT CONSTELLATION SHAPING

(71) Applicant: QUALCOMM Incorporated, San Diego, CA (US)

(72) Inventors: Changlong XU, Beijing (CN); Liangming WU, Beijing (CN); Wei LIU, Beijing (CN); Jian LI, Shanghai (CN); Hao XU, Beijing (CN)

(21) Appl. No.: 19/160,793

(22) PCT Filed: May 6, 2023
(86) PCT No.: PCT/CN2023/092441

§ 371 Date: Aug. 28, 2025

(51) Int. Cl. H04L 5/00; H04L 1/00

(52) U.S. Cl. CPC H04L 5/0053; H04L 1/0004; H04L 1/001

(57) ABSTRACT

Methods, systems, and devices for wireless communication are described. A wireless device may generate a set of shaping bits based on performing a constellation shaping operation on a set of information bits. Further, the wireless device may perform a first error correction encoding operation based on the set of shaping bits and a second error correction encoding operation based on the set of information bits to generate a first set of coded bits and a second set of coded bits, respectively. Moreover, the wireless device may transmit a control message that indicates an offset that identifies a first resource mapping for the first set of coded bits and a second resource mapping for the second set of coded bits and transmit the first set of coded bits in accordance with the first resource mapping and the second set of coded bits in accordance with the second resource mapping.

### CROSS REFERENCE

The present application is a 371 national stage filing of International PCT Application No. PCT/CN2023/092441 by XU et al. entitled “ENCODING SCHEMES FOR WIRELESS COMMUNICATIONS SYSTEMS THAT SUPPORT CONSTELLATION SHAPING,” filed May 6, 2023, which is assigned to the assignee hereof, and which is expressly incorporated by reference in its entirety herein.

### FIELD OF TECHNOLOGY

The following relates to wireless communication, including encoding schemes for wireless communications systems that support constellation shaping.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, a wireless device (e.g., a UE or a network entity) may perform constellation shaping on a set of information bits such that high power symbols are transmitted less frequently than low power symbols in an effort to reduce power.

### SUMMARY

The described techniques relate to improved methods, systems, devices, and apparatuses that support encoding schemes for wireless communications systems that support constellation shaping. The method may include a transmitting device (e.g., a user equipment (UE) or a network entity) generating a set of shaping bits based on performing a constellation shaping operation on a set of information bits. Further, the method may include the transmitting device performing a first error correction encoding (ECE) operation on the set of shaping bits to generate a first set of coded bits and performing a second ECE operation on the set of information bits to generate a second set of coded bits. Moreover, the method may include the transmitting device transmitting a control signal to a receiving device indicating a resource allocation and an offset. The offset may identify a first resource mapping for the first set of coded bits and a second resource mapping for the second set of coded. The transmitting device may then transmit the first set of coded bits and the second set of coded bits to the receiving device in accordance to the first resource mapping and the second resource mapping, respectively. Similar operations may be performed at the receiving device to decode the set of information bits. The methods as described herein may result in power savings as well as a reduction of overhead signaling.

A method for wireless communication at a wireless device is described. The method may include generating a set of shaping bits based on performing a constellation shaping operation on a set of information bits, performing, based on the set of shaping bits, a first ECE operation according to a first coding rate to generate a first set of coded bits, performing, based on the set of information bits, a second ECE operation according to a second coding rate to generate a second set of coded bits, transmitting at least one control message indicating a resource allocation and an offset that identifies a first resource mapping within the resource allocation for the first set of coded bits and a second resource mapping within the resource allocation for the second set of coded bits, the offset corresponding to the first coding rate and the second coding rate, and transmitting, via the resource allocation, the first set of coded bits in accordance with the first resource mapping and the second set of coded bits in accordance with the second resource mapping based on the at least one control message.

An apparatus for wireless communication at a wireless device is described. The apparatus may include a processor, memory coupled with the processor, and instructions stored in the memory. The instructions may be executable by the processor to cause the apparatus to generate a set of shaping bits based on performing a constellation shaping operation on a set of information bits, perform, based on the set of shaping bits, a first ECE operation according to a first coding rate to generate a first set of coded bits, perform, based on the set of information bits, a second ECE operation according to a second coding rate to generate a second set of coded bits, transmit at least one control message indicating a resource allocation and an offset that identifies a first resource mapping within the resource allocation for the first set of coded bits and a second resource mapping within the resource allocation for the second set of coded bits, the offset corresponding to the first coding rate and the second coding rate, and transmit, via the resource allocation, the first set of coded bits in accordance with the first resource mapping and the second set of coded bits in accordance with the second resource mapping based on the at least one control message.

Another apparatus for wireless communication at a wireless device is described. The apparatus may include means for generating a set of shaping bits based on performing a constellation shaping operation on a set of information bits, means for performing, based on the set of shaping bits, a first ECE operation according to a first coding rate to generate a first set of coded bits, means for performing, based on the set of information bits, a second ECE operation according to a second coding rate to generate a second set of coded bits, means for transmitting at least one control message indicating a resource allocation and an offset that identifies a first resource mapping within the resource allocation for the first set of coded bits and a second resource mapping within the resource allocation for the second set of coded bits, the offset corresponding to the first coding rate and the second coding rate, and means for transmitting, via the resource allocation, the first set of coded bits in accordance with the first resource mapping and the second set of coded bits in accordance with the second resource mapping based on the at least one control message.

A non-transitory computer-readable medium storing code for wireless communication at a wireless device is described. The code may include instructions executable by a processor to generate a set of shaping bits based on performing a constellation shaping operation on a set of information bits, perform, based on the set of shaping bits, a first ECE operation according to a first coding rate to generate a first set of coded bits, perform, based on the set of information bits, a second ECE operation according to a second coding rate to generate a second set of coded bits, transmit at least one control message indicating a resource allocation and an offset that identifies a first resource mapping within the resource allocation for the first set of coded bits and a second resource mapping within the resource allocation for the second set of coded bits, the offset corresponding to the first coding rate and the second coding rate, and transmit, via the resource allocation, the first set of coded bits in accordance with the first resource mapping and the second set of coded bits in accordance with the second resource mapping based on the at least one control message.

In some examples of the method, apparatuses, and non-transitory computer-readable medium described herein, transmitting the at least one control message may include operations, features, means, or instructions for transmitting a first control message indicating the offset and transmitting a second control message indicating the resource allocation.

In some examples of the method, apparatuses, and non-transitory computer-readable medium described herein, transmitting the at least one control message may include operations, features, means, or instructions for transmitting a first control message indicating a modulation and coding scheme (MCS) table, where the MCS table includes an indication of a set of multiple coding rates associated with the set of shaping bits and transmitting a second control message including an index to the MCS table that identifies a third coding rate of the set of multiple coding rates that may be applied during the constellation shaping operation.

Some examples of the method, apparatuses, and non-transitory computer-readable medium described herein may further include operations, features, means, or instructions for mapping the first set of coded bits to a first set of consecutive resource elements (REs) according to the first resource mapping and the second set of coded bits to a second set of consecutive REs different from the first set of consecutive REs according to the second resource mapping, where the resource allocation includes the first set of consecutive REs and the second set of consecutive REs.

In some examples of the method, apparatuses, and non-transitory computer-readable medium described herein, mapping the first set of coded bits and the second set of coded bits may include operations, features, means, or instructions for mapping the first set of coded bits to the first set of consecutive REs using a frequency-first, time-second mapping scheme and mapping, after mapping the first set of coded bits, the second set of coded bits to the second set of consecutive REs using the frequency-first, time-second mapping scheme.

In some examples of the method, apparatuses, and non-transitory computer-readable medium described herein, transmitting the first set of coded bits and the second set of coded bits may include operations, features, means, or instructions for transmitting the first set of coded bits using the first set of consecutive REs and transmitting the second set of coded bits using the second set of consecutive REs.

In some examples of the method, apparatuses, and non-transitory computer-readable medium described herein, the offset identifies a relationship between the first coding rate and the second coding rate.

Some examples of the method, apparatuses, and non-transitory computer-readable medium described herein may further include operations, features, means, or instructions for modulating the first set of coded bits using a first modulation scheme and modulating the second set of coded bits using a second modulation scheme, where a modulation order associated with the first modulation scheme may be smaller than a modulation order associated with the second modulation scheme.

In some examples of the method, apparatuses, and non-transitory computer-readable medium described herein, performing the constellation shaping operation may include operations, features, means, or instructions for inputting the set of information bits to a block decoder to generate the set of shaping bits, inputting the set of shaping bits into a block encoder to generate a set of output bits, and applying a Boolean function to the set of information bits and the set of output bits to generate a third set of bits, where the second set of coded bits may be generated based on performing the second ECE operation to the third set of bits according to the second coding rate.

In some examples of the method, apparatuses, and non-transitory computer-readable medium described herein, a code type associated with the block encoder or the block decoder includes polar code, Hamming code, Bose-Chaudhuri-Hocquenghem (BCH) code, Reed-Solomon code, or low density parity check (LDPC) code.

Some examples of the method, apparatuses, and non-transitory computer-readable medium described herein may further include operations, features, means, or instructions for inputting the set of shaping bits into a cyclic redundancy check (CRC) encoder to generate a set of CRC bits, where the first set of coded bits includes the set of CRC bits.

Some examples of the method, apparatuses, and non-transitory computer-readable medium described herein may further include operations, features, means, or instructions for receiving a feedback message indicating whether one or both of the first set of coded bits or the second set of coded bits were decoded successfully.

In some examples of the method, apparatuses, and non-transitory computer-readable medium described herein, transmitting the at least one control message may include operations, features, means, or instructions for transmitting a radio resource control (RRC) message, downlink control information (DCI), a medium access control control element (MAC-CE), or a combination thereof, where the RRC message, the DCI, or the MAC-CE indicates one or both of the resource allocation or the offset.

In some examples of the method, apparatuses, and non-transitory computer-readable medium described herein, a code type associated with the first ECE operation may be different than a code type associated with the second ECE operation.

In some examples of the method, apparatuses, and non-transitory computer-readable medium described herein, the code type associated with the first ECE operation includes polar code and the code type associated with the second ECE operation includes LDPC code.

A method for wireless communication at a wireless device is described. The method may include receiving at least one control message indicating a resource allocation and an offset that identifies a first resource mapping within the resource allocation for a first set of coded bits and a second resource mapping within the resource allocation for a second set of coded bits, the offset corresponding to a first coding rate associated with the first set of coded bits and a second coding rate associated with the second set of coded bits, receiving, via the resource allocation, the first set of coded bits in accordance with the first resource mapping and the second set of coded bits in accordance with the second resource mapping based on the at least one control message, performing, based on the first set of coded bits, a first error correction decoding (ECD) operation to generate a set of shaping bits, performing, based on the second set of coded bits, a second ECD operation to generate a set of decoded bits, and generating, based on the set of decoded bits and the set of shaping bits and using a constellation deshaping operation, a set of information bits.

An apparatus for wireless communication at a wireless device is described. The apparatus may include a processor, memory coupled with the processor, and instructions stored in the memory. The instructions may be executable by the processor to cause the apparatus to receive at least one control message indicating a resource allocation and an offset that identifies a first resource mapping within the resource allocation for a first set of coded bits and a second resource mapping within the resource allocation for a second set of coded bits, the offset corresponding to a first coding rate associated with the first set of coded bits and a second coding rate associated with the second set of coded bits, receive, via the resource allocation, the first set of coded bits in accordance with the first resource mapping and the second set of coded bits in accordance with the second resource mapping based on the at least one control message, perform, based on the first set of coded bits, a first ECD operation to generate a set of shaping bits, perform, based on the second set of coded bits, a second ECD operation to generate a set of decoded bits, and generate, based on the set of decoded bits and the set of shaping bits and using a constellation deshaping operation, a set of information bits.

Another apparatus for wireless communication at a wireless device is described. The apparatus may include means for receiving at least one control message indicating a resource allocation and an offset that identifies a first resource mapping within the resource allocation for a first set of coded bits and a second resource mapping within the resource allocation for a second set of coded bits, the offset corresponding to a first coding rate associated with the first set of coded bits and a second coding rate associated with the second set of coded bits, means for receiving, via the resource allocation, the first set of coded bits in accordance with the first resource mapping and the second set of coded bits in accordance with the second resource mapping based on the at least one control message, means for performing, based on the first set of coded bits, a first ECD operation to generate a set of shaping bits, means for performing, based on the second set of coded bits, a second ECD operation to generate a set of decoded bits, and means for generating, based on the set of decoded bits and the set of shaping bits and using a constellation deshaping operation, a set of information bits.

A non-transitory computer-readable medium storing code for wireless communication at a wireless device is described. The code may include instructions executable by a processor to receive at least one control message indicating a resource allocation and an offset that identifies a first resource mapping within the resource allocation for a first set of coded bits and a second resource mapping within the resource allocation for a second set of coded bits, the offset corresponding to a first coding rate associated with the first set of coded bits and a second coding rate associated with the second set of coded bits, receive, via the resource allocation, the first set of coded bits in accordance with the first resource mapping and the second set of coded bits in accordance with the second resource mapping based on the at least one control message, perform, based on the first set of coded bits, a first ECD operation to generate a set of shaping bits, perform, based on the second set of coded bits, a second ECD operation to generate a set of decoded bits, and generate, based on the set of decoded bits and the set of shaping bits and using a constellation deshaping operation, a set of information bits.

In some examples of the method, apparatuses, and non-transitory computer-readable medium described herein, receiving the at least one control message may include operations, features, means, or instructions for receiving a first control message indicating the offset and receiving a second control message indicating the resource allocation.

In some examples of the method, apparatuses, and non-transitory computer-readable medium described herein, receiving the at least one control message may include operations, features, means, or instructions for receiving an RRC message, DCI, a MAC-CE, or a combination thereof, where the RRC message, the DCI, or the MAC-CE indicates one or both of the resource allocation or the offset.

In some examples of the method, apparatuses, and non-transitory computer-readable medium described herein, receiving the first set of coded bits and the second set of coded bits may include operations, features, means, or instructions for receiving the first set of coded bits using a first set of consecutive REs according to the first resource mapping and receiving the second set of coded bits using a second set of consecutive REs different than the first set of consecutive REs according to the second resource mapping, where the resource allocation includes the first set of consecutive REs and the second set of consecutive REs.

Some examples of the method, apparatuses, and non-transitory computer-readable medium described herein may further include operations, features, means, or instructions for determining a number of REs included in the first set of consecutive REs based on the offset.

In some examples of the method, apparatuses, and non-transitory computer-readable medium described herein, receiving the at least one control message may include operations, features, means, or instructions for receiving a first control message indicating a MCS table, where the MCS table includes an indication of a set of multiple coding rates associated with the set of shaping bits and receiving a second control message including an index to the MCS table that identifies a third coding rate of the set of multiple coding rates that may be applied during a constellation shaping operation.

Some examples of the method, apparatuses, and non-transitory computer-readable medium described herein may further include operations, features, means, or instructions for demodulating the first set of coded bits using a first modulation scheme and demodulating the second set of coded bits using a second modulation scheme, where a modulation order associated with the first modulation scheme may be smaller than a modulation order associated with the second modulation scheme.

In some examples of the method, apparatuses, and non-transitory computer-readable medium described herein, performing the constellation deshaping operation may include operations, features, means, or instructions for inputting the set of shaping bits into a block encoder to generate a set of output bits and applying a Boolean function to the set of decoded bits and the set of output bits to generate the set of information bits.

In some examples of the method, apparatuses, and non-transitory computer-readable medium described herein, a code type associated with the block encoder includes polar code, hamming code, BCH code, Reed-Solomon code, or LDPC code.

In some examples of the method, apparatuses, and non-transitory computer-readable medium described herein, the first set of coded bits includes a set of cyclic redundancy bits and the method, apparatuses, and non-transitory computer-readable medium may include further operations, features, means, or instructions for generating, based on the first set of coded bits, the set of shaping bits using a CRC decoder.

Some examples of the method, apparatuses, and non-transitory computer-readable medium described herein may further include operations, features, means, or instructions for transmitting a feedback message indicating whether one or both of the first set of coded bits or the second set of coded bits were decoded successfully.

In some examples of the method, apparatuses, and non-transitory computer-readable medium described herein, the offset identifies a relationship between the first coding rate and the second coding rate.

In some examples of the method, apparatuses, and non-transitory computer-readable medium described herein, a code type associated with the first ECD operation may be different than a code type associated with the second ECD operation.

In some examples of the method, apparatuses, and non-transitory computer-readable medium described herein, the code type associated with the first ECD operation includes polar code and the code type associated with the second ECD operation includes LDPC code.

### BRIEF DESCRIPTION OF THE DRAWINGS

FIGS. 1 and 2 show an example of a wireless communications system that supports encoding schemes for wireless communications systems that support constellation shaping in accordance with one or more aspects of the present disclosure.

FIG. 3 shows an example of a transmitter component diagram that supports encoding schemes for wireless communications systems that support constellation shaping in accordance with one or more aspects of the present disclosure.

FIG. 4 shows an example of a receiver component diagram that supports encoding schemes for wireless communications systems that support constellation shaping in accordance with one or more aspects of the present disclosure.

FIG. 5 shows an example of a process flow that supports encoding schemes for wireless communications systems that support constellation shaping in accordance with one or more aspects of the present disclosure.

FIGS. 6 and 7 show block diagrams of devices that support encoding schemes for wireless communications systems that support constellation shaping in accordance with one or more aspects of the present disclosure.

FIG. 8 shows a block diagram of a communications manager that supports encoding schemes for wireless communications systems that support constellation shaping in accordance with one or more aspects of the present disclosure.

FIG. 10 shows a diagram of a system including a UE that supports encoding schemes for wireless communications systems that support constellation shaping in accordance with one or more aspects of the present disclosure.

FIG. 9 shows a diagram of a system including a network entity that supports encoding schemes for wireless communications systems that support constellation shaping in accordance with one or more aspects of the present disclosure.

FIGS. 11 through 14 show flowcharts illustrating methods that support encoding schemes for wireless communications systems that support constellation shaping in accordance with one or more aspects of the present disclosure.

### DETAILED DESCRIPTION

In some examples, a wireless device (e.g., a user equipment (UE) or a network entity) may utilize constellation shaping. Constellation shaping may allow the wireless device to manipulate information bits such that symbols associated with a high transmission power are transmitted less frequently than symbols associated with a low transmission power. When constellation shaping is performed on the information bits, shaping bits are generated. To ensure both the shaping bits and the information bits are protected from errors, both the shaping bits and the information bits may undergo a joint error correction protection operation. During the joint error correction operation, the information bits and the shaping bits may be input into a single error correction encoder (e.g., low density parity check (LDPC) encoder) and parity bits may be generated for both the information bits and the shaping bits. After the joint error correction operation, the parity bits and the shaping bits may be mapped to a sign of symbols and the information bits may be mapped to an amplitude of symbols. However, in some examples, the number of shaping bits may be relatively large and the wireless device may be unable to map all of the parity bits as well as the shaping bits to the sign of the symbols.

As described herein, shaping bits and information bits may undergo separate error correction operations such that shaping bits may be transmitted along with an uplink or downlink transmission to reduce signaling overhead while using LPDC coding changes in existing wireless devices. In some examples, a transmitting device may perform constellation shaping on information bits to generate shaping bits and shaped information bits. After performing the constellation shaping operation, the shaped information bits may be input into a first error correction encoder and a first set of coded bits may be generated (e.g., the shaped information bits and parity bits). Additionally, the shaped bits may be input into a second error correction encoder and a second set of coded bits may be generated (e.g., the shaping bits and parity bits).

After performing the separate error correction operations, the transmitting device may transmit the first set of coded bits and the second set of coded bits to a receiving device using resources of a resources allocation (e.g., a physical uplink shared channel (PUSCH)/physical downlink shared channel (PDSCH) resource allocation). Further, in some examples, prior to transmitting the first set of coded bits and the second set of coded bits, the transmitting device may transmit a control message to the receiving device that indicates an offset value that identifies a first resource mapping for the first set of coded bit and a second resource mapping for the second set of coded bits such that the receiving device may differentiate between the resources used to transmit first set of coded bits from the resources used to transmit the second set of coded bits. The receiving device may utilize similar procedures as the transmitting device to retrieve the information bits (e.g., use separate error correction decoder for shaped bits and information bits).

Aspects of the disclosure are initially described in the context of wireless communications systems. Additional aspects of the disclosure are described in the context of a transmitter component diagram, a receiver component diagram, and a process flow. Aspects of the disclosure are further illustrated by and described with reference to apparatus diagrams, system diagrams, and flowcharts that relate to encoding schemes for wireless communications systems that support constellation shaping.

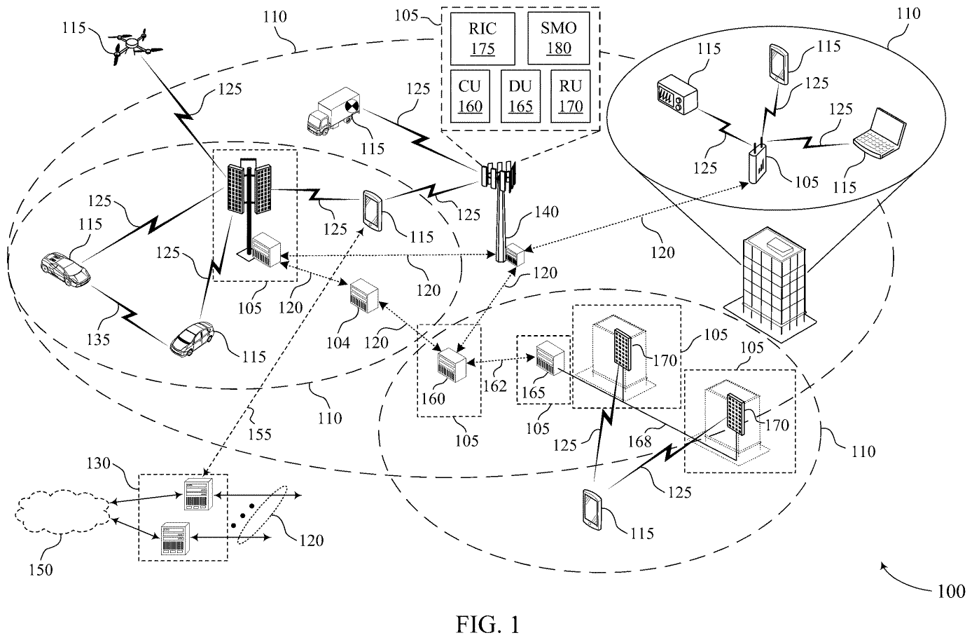

FIG. 1 shows an example of a wireless communications system 100 that supports encoding schemes for wireless communications systems that support constellation shaping in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support encoding schemes for wireless communications systems that support constellation shaping as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element (RE) may refer to resources of one symbol period (e.g., a duration of one modulation symbol) and one subcarrier, in which case the symbol period and subcarrier spacing may be inversely related. The quantity of bits carried by each RE may depend on the modulation scheme (e.g., the order of the modulation scheme, the coding rate of the modulation scheme, or both), such that a relatively higher quantity of REs (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

As described herein, a wireless device may implement an encoding scheme that supports constellation shaping. In some examples, a transmitting device (e.g., the UE 115 or the network entity 105) may generate a set of shaping bits based on performing a constellation shaping operation on a set of information bits. Further, the transmitting device may perform a first ECE operation on the set of shaping bits to generate a first set of coded bits and perform a second ECE operation on the set of information bits to generate a second set of coded bits. Moreover, the transmitting device may transmit a control signal to a receiving device (e.g., the UE 115 or the network entity 105) that indicates a resource allocation and an offset. The offset may identify a first resource mapping for the first set of coded bits and a second resource mapping for the second set of coded. The transmitting device may then transmit the first set of coded bits and the second set of coded bits to the receiving device in accordance to the first resource mapping and the second resource mapping, respectively. Similar operations may be performed at the receiving device to decode the set of information bits. The methods as described herein may result in power savings as well as a reduction of overhead signaling.

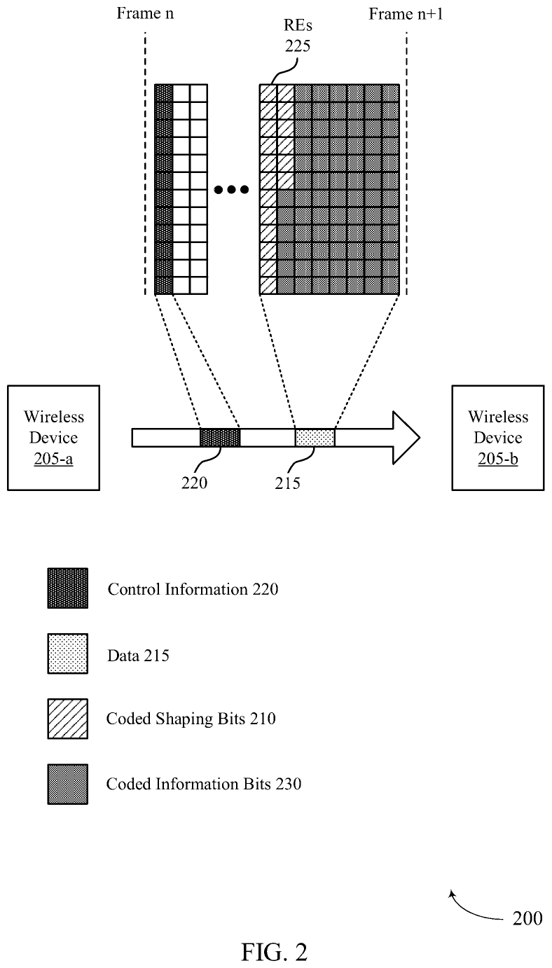

FIG. 2 shows an example of a wireless communications system 200 that supports encoding schemes for wireless communications systems that support constellation shaping in accordance with one or more aspects of the present disclosure. In some examples, the wireless communications system 200 may include wireless devices 205 which may be examples of UEs 115 or network entities 105 as described with reference to FIG. 1.

In some examples, the wireless communications system 200 may support a wireless device 205-a and a wireless device 205-b. The wireless device 205-a and the wireless device 205-b may be examples of a UE or a network entity. In the example of FIG. 2, the wireless device 205-a may include a transmitting device and the wireless device 205-b may include a receiving device. In such example, the wireless device 205-a may include one or more components configured to transmit signaling to the wireless device 205-b and the wireless device 205-b may include one or more components configured to receive the signaling from the wireless device 205-a.

In order to transmit the signaling to the wireless device 205-b, the wireless device 205-a may perform one or more operations. For example, the wireless device 205-a may perform constellation shaping. Constellation shaping may allow the wireless device 205-a to manipulate information bits such that lower power symbols are transmitted at a higher probability than higher power symbols. One example of constellation shaping may be geometric shaping. During geometric shaping, constellation points may be distributed non-uniformly (e.g., in one dimension or two dimensions). For example, more constellation points may be located in areas where the amplitude is small and fewer constellation points may be gathered where the amplitude is high. In geometric shaping, searching via numeric or any other heuristic or machine learning approach may be performed. In some examples, geometric shaping may result in high demodulation complexity at the receiver side. Further, geometric shaping may be associated with a lower gain when compared to other types of constellation shaping (e.g., probabilistic shaping).

Another type of constellation shaping may be probabilistic shaping. During probabilistic shaping, a distribution mapper may be applied to the information bits. The distribution mapper may convert the information bits into symbols with a desired distribution. In some examples, the desired distribution may be a distribution that produces a desired signal-to-noise ratio (SNR) (e.g., a tunable SNR specific symbol distribution) or a desired transmit power. For example, the distribution may be a Maxwell-Boltzman distribution. Probabilistic shaping may result in less demodulation complexity at the receiver side than other types of constellation shaping (e.g., geometric shaping). However, unlike other types of constellation shaping, probabilistic shaping may require a new component (e.g., the distribution mapper) to be introduced into the wireless devices 205-a as well as the wireless device 205-b.

Yet another type of constellation shaping may be probabilistic amplitude shaping. In some examples, each symbol may include two or more bits. The first bit of the two or more bits may be known as the most-significant bit (MSB) and may contribute to the transmit power more so than other bits of the two or more bits. For example, the transmit power may be lower if a logic value of the MSB is 0 than when the logic value of the MSB is 1. Using probabilistic amplitude shaping, a probability of the MSB may be changed such that more 0s are transmitted than 1s. To change the probability of a certain logic value of the MSBs, a bit-mask may be applied to the MSBs via an extra channel decoder (e.g., a channel decoder included in a shaping encoder of the wireless device 205-a). But prior to applying the bit-mask, the wireless device 205-a may input the information bits into an log-likelihood ratio (LLR) generator. The LLR generator may determine the potential power savings after bit-masking (or bit flipping) the MSBs of the information bits (e.g., a portion of the information bits) and from this, the wireless device 205-a may determine whether bit-masking the MSBs will result in transmit power savings.

As one example, a set of information bits may include a first subset of information bits (100101) and a second subset of information bits (110100). The first subset of information bits may be the MSBs of the set of information bits (or u₀) and the second subset of information bits may be the other information bits (or u₁). Each bit of the first subset of information bits may correspond with a bit of the second subset of information bits and each pair may correspond to a different symbol. In such example, the pairs of information bits inputted into the LLR generator may be (11), (01), (00), (11), (00), and (10).

Once inputted into the LLR generator, the LLR generator may apply a bit-mask to the MSBs (or u₀) resulting in the following pairs of bits: (01), (11), (10), (01), (10), and (00), as displayed in Table 1 and represented by symbol index 1, 2, 3, 4, 5, and 6, respectively. The transmit power of a symbol may be 1, 9, 25, or 49 (e.g., depending on the amplitude of the symbol), with 1 being the lowest transmit power and 49 being the highest transmit power. The LLR generator may determine the LLR (or power savings) of each pair of bits. For example, the original transmit power of the symbol with symbol index 1 may be 25 and after bit-masking, the transmit power of the symbol with symbol index 1 may be 9 resulting in an LLR (power savings delta) of −16. The resulting LLR for the pairs as displayed in Table 1 may be −16, 16, 48, −16, 48, and −48.

TABLE 1
LLR Generator.

| Symbol Index | 1 | 2 | 3 | 4 | 5 | 6 |
|---|---|---|---|---|---|---|
| u₀ | 0 | 1 | 1 | 0 | 1 | 0 |
| u₁ | 1 | 1 | 0 | 1 | 0 | 0 |
| Amplitude (Original) | 5 | 3 | 1 | 5 | 1 | 7 |
| Tx Power (Original) | 25 | 9 | 1 | 25 | 1 | 49 |
| Tx Power (After Bit | 9 | 25 | 49 | 9 | 49 | 1 |
| Masking) | | | | | | |
| LLR | −16 | 16 | 48 | −16 | 48 | −48 |

The results of the LLR generator (e.g., −16, 16, 48, −16, 48, −48) may be input into a shaping encoder of the wireless device 205-a (e.g., a decoder of the shaping encoder) and the shaping encoder may output a set of shaping bits (or s) and a set of output bits (or v). The set of shaping bits may indicate whether the bit-masking was applied to the MSB and the output bits may be used to shape the information bits (e.g., may be used to apply the bit-mask to the MSBs or u₀). In some examples, a number of shaping bits may depend on a code rate of the decoder of the shaping encoder (e.g., s=u₀*R, where R is the code rate) and a number of the output bits may be equal to u₀. The wireless device 505-a may determine the code rate of the decoder from an modulation and coding scheme (MCS) table configured at the wireless device 505-a.

Further, the shaping encoder may apply a Boolean function (e.g., an eXclusive OR (XOR) Boolean operation) to the information bits (or u₀) and the output bits to generate the shaped information bits. Performing probabilistic amplitude shaping may result in less latency and demodulation complexity when compared to other types of constellation shaping (e.g., geometric shaping or probabilistic shaping). Further, a wireless device 205-a does not require a distribution mapper to perform probabilistic amplitude shaping.

Further, prior to transmitting the information bits, the transmitting device (e.g., the wireless device 205-a) may perform an error correction operation on the set of shaping bits and the shaped information bits such that errors (e.g., errors resulting from transmitting the information bits from the wireless device 105-a to the wireless device 105-b) may be detected and potentially corrected in the information bits. To perform the error correction operation, the wireless device 105-a may input the shaped information bits (e.g., shaped u₀ and unshaped u₁) as well as the shaping bits into an error correction encoder (e.g., FEC encoder). That is, the wireless device 105-a may jointly encode the shaping bits and the shaped information bits using a single error correction encoder. Output from the error correction encoder may be the shaped information bits, shaping bits, and parity bits.

After performing the error correction operation, the wireless device 205-a may map the shaped information bits, the shaping bits, and the parity bits to symbols. In some examples, the shaping bits and the parity bits may be mapped to the sign of the symbols and the shaped information bits may be mapped to the amplitude of the symbols. However, using a single error correction encoder for both the shaping bits and the shaped information bits may result in some issues. For example, the method of using a single error correction encoder for both shaping bits and the shaped information bits may not align with the current channel coding chain. Further, latency of the system may increase in order to encode both shaping bits and the shaped information bits with a single error correction encoder. Moreover, the number of shaping bits may be relatively large and the wireless device 205-a may be unable to map all of the parity bits and shaping bits to the sign bits of the symbols.

As described herein, the shaping bits and the shaped information bits may be encoded separated during the error correction operation. That is, the wireless device 205-a may include two separate error correction encoders and perform two separate error correction operations. A first error correction encoder may be allocated for the shaping bits and a second error correction encoder may be allocated for the shaped information bits. As part of a first ECE operation, the wireless device 205-a may input the shaped information bits into the first error correction encoder and the first error correction encoder may output the shaped information bits and a first set of parity bits corresponding to the shaped information bits (collectively known as coded information bits 230). Similarly, as part of a second ECE operation, the wireless device 205-a may input the shaping bits into the second error correction encoder and the second error correction encoder may output a second set of parity bits corresponding to the shaping bits (collectively known as coded shaping bits 210). In some examples, the first error correction encoder and the second error correction encoder may utilize polar code, LDPC code, Hamming code, Bose-Chaudhuri-Hocquenghem (BCH) code, or Reed-Solomon Code.

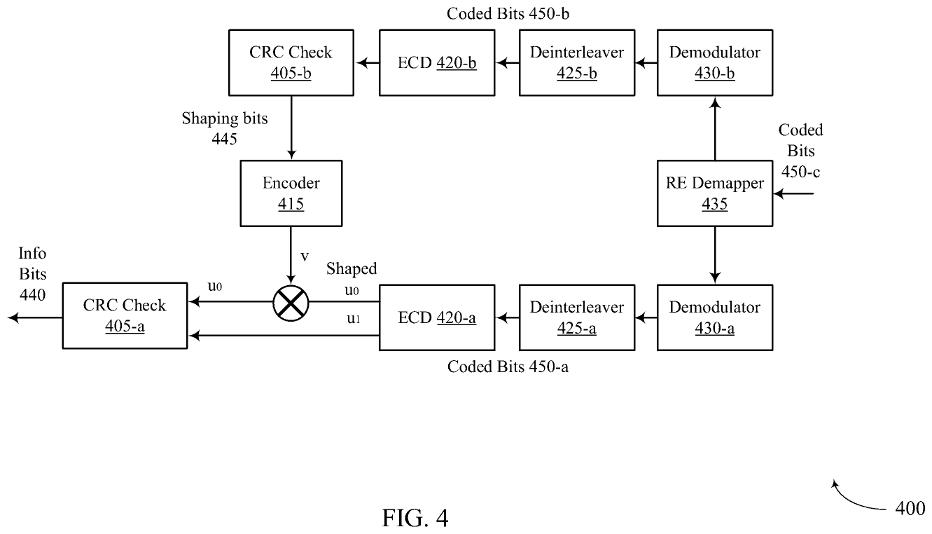

Further, the shaped information bits and the shaping bits may undergo separate modulation operations. The wireless device 205-a may map the coded information bits 230 to a first set of symbols. In some examples, the shaped information bits of the coded information bits 230 may be mapped to the amplitude of the symbols of the first set of symbols and the first set of parity bits of the coded information bits 230 may be mapped to the sign of the symbols of the first set of symbols. Further, the wireless device 205-a may map the coded shaping bits 210 to a second set of symbols. In some examples, the shaping bits and the second set of parity bits of the coded shaping bits 210 may be mapped to either the sign or the amplitude of the symbols of the second set of symbols. Using such methods may not change the current channel coding chain. Further, encoding the shaping bits and the shaped information bits separately during the error correction may decrease latency. Moreover, the methods as described herein may allow the wireless device 205-a to map the shaping bits to the amplitude or sign of the symbols which may provide enough capacity for all of the shaping bits. Similar procedure may be performed at the receiving device (e.g., the wireless device 205-b) to receive and decode the information bits as described in more detail in FIG. 4.

Additionally, to decrease the signaling overhead associated with transmitting the coded shaping bits, the wireless device 205-a may transmit the coded shaping bits 210 using at least a portion of resources allocated for the coded information bits 230 (e.g., PDSCH/PUSCH resources). That is, the coded shaping bits 210 may be piggybacked over the PDSCH/PUSCH resources that are used for the transmission of the coded information bits 230. In such example, the wireless device 205-a or another wireless device 205 may transmit control information 220 (e.g., downlink control information (DCI)) to the wireless device 205-b that indicates a set of resources (e.g., PDSCH/PUSCH resources) for data 215. Additionally, the control information 220 may indicate an offset value. The offset value may be included in a new content field or an existing content field in the DCI. Alternatively, the offset value may be configured via RRC signaling or the offset value may be included in a MAC-control element (MAC-CE). The offset value may be a difference between a coding rate of the shaping bits and a coding rate of the information bits and may be used by the wireless device 205-b to determine that a portion of the PDSCH/PUSCH resources will be used to receive the coded shaping bits 210 (or determine a first resource mapping) and which portion of the PDSCH/PUSCH resources will be used to receive the coded information bits 230 (or determine a second resource mapping). In some examples, the UE may use the indicated offset value for both PUSCH and PDSCH when block code based constellation shaping is applied.

In some examples, the PUSCH/PDSCH resources may be divided into a set of REs 225. Each RE 225 of the set may occupy a set of time resources (e.g., one OFDM symbol) and a set of frequency resources (e.g., one subcarrier). Using the offset, the wireless device 205-b may determine a number REs 225 of the PDSCH/PUSCH resources that will be used to receive the coded shaping bits 210. For example, the wireless device 205-b may utilize Equation 1 to determine the number of REs 225 allocated for the coded shaping bits. In Equation 1, N_{RE,S} may represent a number of REs 225 allocated for the coded shaping bits, K_{S} may be represent a number of coded shaping bits 210, β_{offset} may represent the offset value, K_{SCH} may be the number of coded information bits 230 which can be derived from a transport block (TB) size, and E may represent a total number of REs 225 of the PUSCH/PDSCH resources.

$${N}_{RE , S} = \frac{{K}_{S} * {β}_{offse𝔱}}{{K}_{SCH}} * E \qquad ( 1 )$$

In some examples, the wireless device 205-a may map the coded shaping bits 210 to the REs 225 of the PUSCH/PDSCH resources prior to mapping the coded information bits 230 and according to a frequency-first, time-second mapping scheme. For example, as shown in FIG. 2, the first N_{RE,S} of the REs 225 of the PUSCH/PDSCH resources may be allocated to the coded shaping bits 210 and the remaining REs 225 of the PUSCH/PDSCH resources may be allocated to the coded information bits 230. Thus, using the above methods, the wireless device 205-b may differentiate between the coded shaping bits 210 and the coded information bits 230 in a DL or UL data transmission (or determine a first resource mapping for the coded shaping bits 210 and a second resource mapping for the coded information bits 230) which may allow the wireless device 205-a to utilize PDSCH/PUSCH resources for transmitting both coded information bits 230 as well as coded shaping bits 210 reducing overhead signaling associated with transmitting the shaped coded bits.

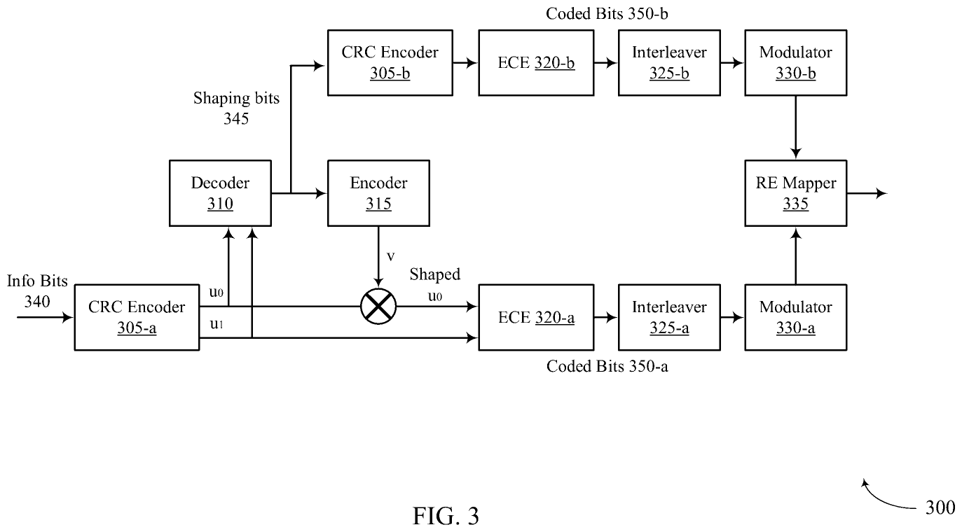

FIG. 3 shows an example of a transmitter component diagram 300 that supports encoding schemes for wireless communications systems that support constellation shaping in accordance with one or more aspects of the present disclosure. In some examples, the transmitter component diagram 300 may be implemented by aspects of a wireless communications system 100 and a wireless communications system 200. For example, the transmitter component diagram 300 may be implemented by a network entity 105, a UE 115, or a wireless device 205 as described with reference to FIGS. 1 and 2.

In some examples, data may arrive at a transmitting device and the data may include a set of information bits 340 (or u). The set of information bits 340 may be split into two different subsets of bits. For example, the set of information bits 340 may be split into uₒ and u₁. uₒ may represent the MSBs of the set of information bits 340 and u₁ may represent the other bits of the set of information bits 340. In some examples, a size of the set of information bits 340, or more specifically uₒ, (e.g., a number of bits) may be a multiple of a number of modulation symbols depending on how many bits per symbol will be shaped (e.g., XOR'd). For example, the size of the set of information bits 340 or uₒ may be double the modulation symbols if high reliability bits are shaped.

After data arrives at the transmitting device, the transmitting device may input the set of information bits 340 into a CRC encoder 305-a. Using the CRC encoder 305-a, the transmitting device may append CRC bits to the set of information bits 340 for the purpose of detecting accidental changes or errors to the set of information bits 340 in a communication channel.

After going through the CRC encoder 305-a, uₒ and u₁ may flow to a constellation shaping encoder that performs a constellation shaping operations on a set of information bits. The constellation shaping encoder may include a decoder 310 and an encoder 315. Additionally, u₁ may flow to the ECE 320-a. Using the constellation shaping encoder, the transmitting device may perform a constellation shaping operation (e.g., a probabilistic amplitude shaping operation) on the set of information bits 340. As described with reference to FIG. 2, the constellation shaping operation may allow that transmitting device to transform the set of information bits 340 in such a way that higher power symbols are transmitted less frequently than lower power symbols. In some examples, the transmitting device may calculate an LLR of uₒ and u₁ (e.g., a power savings analysis) and input the LLR into the decoder 310. Based on the LLR and uₒ, the decoder 310 may output a set of shaping bits 345 (or s). A quantity of shaping bits 345 may depend on a code rate of the decoder 310 which may be related to SNR (e.g., s=u₀*R, where R is the coding rate). In the case of the decoder 310, the code rate may be the ratio between the number of shaping bits 345 and the number of information bits 340 or u₀. Common code rate values may be ½, ⅔, ¾, etc. The shaping bits 345 may then proceed to the CRC encoder 305-b and an encoder 315.

At the encoder 315, the transmitting device may calculate a set of output bits (or v). the transmitting device may then XOR v with uₒ. In some examples, applying the Boolean function (e.g., XOR) to v and uₒ will result in a uₒ that includes more bits with a logic value of 0 (e.g., shaped uₒ) than a logic value of 1. The code type for decoder 310 and the encoder 315 may be Polar code, Hamming code, BCH code, Reed-Solomon code, or LDPC code.

At this point, the set of information bits 340 (e.g., shaped uₒ and unshaped u₁) and the shaping bits 345 may undergo separate error correction operations. First, the shaping bits 345 may flow from the decoder 310 to the CRC encoder 305-b. At the CRC encoder 305-b, the transmitting device may append CRC bits to the shaping bits 345 for the purpose of detecting accidental changes or errors to the shaping bits 345 in the communication channel. A length of the CRC bits may be different for different code types. For example, part of the CRC bits may be used for polar decoding with CRC-aided list decoding. Alternatively, for LDPC codes, part of the CRC bits are used for BP decoding with a large number of iteration.

After the CRC encoder 305-b, the shaping bits 345 (with the appended CRC bits) may flow to the ECE 320-b and the transmitting device may perform a first error correction encoding procedure on the shaping bits using the ECE 320-b. During the first error correction encoding procedure, the ECE 320-b may generate a first set of parity bits using the shaping bits 345 for a first coding rate, and output the shaping bits 345 as well as the first set of parity bits which may be collectively known as coded bits 350-b. A code type of the ECE 320-b may be LDPC code or polar code. In some examples, it may be beneficial for the ECE 320-b to utilize polar code because the size of the shaping bits 345 may be smaller than the size of the information bits and polar code may outperform LDPC code for small block sizes. In some cases, polar encoder may be used with two LDPC encoders in the transmitter and two LDPC decoders in the receiver, where the code rate of a mother code for circular buffer creation may be used if polar coding or LDPC is applied.

After undergoing the first error correction encoding operation, the coded bits 350-b may flow to the interleaver 325-b. The interleaver 325-b may interleave the coded bits 350-b such that an order of the coded bits 350-b is suitable for symbol mapping. If the code type for the ECE 320-b is polar code, the interleaver 325-b may be an example of a triangle interleaver. Alternatively, if the code type for the ECE 320-b is LDPC, the interleaver 325-b may be an example of a block interleaver.

The coded bits 350-b may leave the interleaver 325-b and flow to the modulator 330-b. At the modulator 330-b, the transmitting device may map the coded bits 350-b to a first set of symbols. Each coded bit of the coded bits 350-b may be mapped to either a sign of a symbol of the first set of symbols or an amplitude of the symbol of the first set of symbols. In some examples, the modulators 330-a and 330-b may use the same modulation order for modulating shaping bits and information bits.

In parallel, the shaped information bits (e.g., shaped uₒ and unshaped u₁) may undergo a similar procedure as the shaping bits 345. For example, the shaped information bits may flow to the ECE 320-a (e.g., an ECE separate from the ECE 320-b) and the transmitting device may perform a second error correction procedure on the shaped information bits using the ECE 320-a. During the second error correction procedure, the ECE 320-a may generate a second set of parity bits using the shaped information bits for a second coding rate, and output the shaped information bits as well as the second set of parity bits which may be collectively known as coded bits 350-a. A code type of the ECE 320-a may be LDPC code. The code type of the ECE 320-b and the code type for the ECE 320-a may be the same or different.

After undergoing to the second error correction operation, the coded bits 350-a may flow to the interleaver 325-a. The interleaver 325-a may interleave the coded bits 350-a such that an order of the coded bits 350-a is suitable for symbol mapping. The coded bits 350-b may leave the interleaver 325-a and flow to the modulator 330-a. At the modulator 330-a, the transmitting device may map the coded bits 350-a to a second set of symbols. In some examples, the second set of parity bits may be mapped to a sign of symbols of the second set of symbols and the information bits may be mapped to an amplitude of the symbols of the second set of symbols.

After mapping the coded bits 350-b to the first set of symbols and the coded bits 350-a to the second set of symbols, the transmitting device may map the first set of symbols and the second set of symbols to a set of REs using the RE mapper 335. As described with reference to FIG. 2, the shaping bits may be piggybacked over the information bits. In such case, the transmitting device may map the first set of symbols and the second of symbols to a set of REs that make up a PUSCH/PDSCH resource allocation (e.g., resources allocated for data). Further, in some examples, the transmitting device may first map the first set of symbols to a consecutive number of REs of the set of REs in a frequency-first, time-second manner (e.g., a first resource mapping within the PUSCH/PDSCH resource allocation, corresponding to coded shaping bits 210) and then map the second set of symbols to the remaining REs of the set (e.g., a second resource mapping within PUSCH/PDSCH resource allocation, corresponding to coded information bits 230).

In some examples, the transmitting device may transmit a signal indicating a first resource mapping for the first set of symbols and a second resource mapping for the second set of symbol such that the receiving device may determine which REs (or how many REs) of the PUSCH/PDSCH resource allocation will be utilized to receive the coded bits 350-b and which REs (or how many REs) of the PUSCH/PDSCH resource allocation will be utilized to receive the coded bits 350-a.

In some examples, the signal indicating the first resource mapping and the second resource mapping may include an offset. The offset may indicate a difference between a first coding rate (e.g., a coding rate of the ECE 320-a) and a second coding rate (e.g., a coding rate of the ECE 320-b). The respective coding rates of the ECE 320-a and the ECE 320-b may refer to a proportion of the data-stream that includes information bits relative to redundancy bits. For example, the first coding rate may be a ratio between the number of information bits 340 and the total number of coded bits 350-a. The second coding rate may be a ratio between the number of shaping bits 345 and the total number of coded bits 350-b. The receiving device may utilize the offset to determine the first resource mapping and the second resource mapping or more specifically, a number of REs of the PUSCH/PDSCH resource allocation that will be used to receive the coded bits 350-b. Also with reference to FIG. 2, the offset may be used to indicate a proportion of a resource allocation for coded shaping bits 210 relative to coded information bits. The offset may be adjusted the increase the amount of REs for the coded shaping bits 210, and correspondingly decrease the amount of REs for the coded information bits 230. Conversely, the offset may be adjusted the decrease the amount of REs for the coded shaping bits 210, and correspondingly increase the amount of REs for the coded information bits 230. Once the transmitting device maps the first set of symbols and the second set of symbols to the set of REs, the transmitting device may transmit the coded bits 350-b and the coded bits 350-a to the receiving device using the corresponding REs (and according to the first resource mapping and the second resource mapping).

FIG. 4 shows an example of a receiver component diagram 400 that supports encoding schemes for wireless communications systems that support constellation shaping in accordance with one or more aspects of the present disclosure. In some examples, the receiver component diagram 400 may be implemented by aspects of a wireless communications system 100 and a wireless communications system 200. For example, the receiver component diagram 400 may be implemented by a network entity 105, a UE 115, or a wireless device 205 as described with reference to FIGS. 1 and 2.

In some examples, a receiving device may receive coded bits 450-c from a transmitting device using a set of REs of a PDSCH/PUSCH resource allocation. After receiving the coded bits 450, the receiving device may utilize the RE demapper 435 to determine a first set of symbols that corresponds to a set of shaping bits 445 and a second set of symbols that corresponds to set of information bits 440. In some examples, prior to receiving the coded bits 450-c, the receiving device may receive signaling from the transmitting device indicating a first resource mapping for the first set of symbols and a second resource mapping for the second set of symbols and perform the RE demapping according to first resource mapping and the second resource mapping.

From here, the first set of symbols and the second set of symbols may branch off from one another in the receiver chain. For example, the first set of symbol may flow to the demodulator 430-b while the second set of symbol may flow to the demodulator 430-a. At the demodulator 430-b, the receiving device may generate the coded bits 450-b from the first set of symbols. In some examples, the coded bits 450-b may include the set of shaping bits 445 as well as a first set of parity bits.

After demodulation, the coded bits 450-b may proceed to a deinterleaver 425-b and then to an EC decoder (ECD) 420-b to undergo a first ECD operation. The ECD 420-b may utilize the first set of parity bits to determine whether the set of shaping bits 445 include one or more errors and if the ECD 420-b determines the shaping bits 445 include one or more errors, the ECD 420-b may potentially correct the one or more errors. The ECD 420-b may output the set of shaping bits 445 and the set of shaping bits 445 may flow to a CRC check 405-b. At the CRC check 405-b, the receiving device may check the CRC of the set of shaping bits 445 (e.g., CRC bits appended during transmission) to determine whether the set of shaping bits 445 include any errors. If there are no errors, the shaping bits 445 may continue to the encoder 415. Using the set of shaping bits 445, the encoder 415 may determine a set of output bits, v.

In parallel, the second set of symbols may undergo a similar procedure. For example, at the demodulator 430-a, the receiving device may generate the coded bits 450-a from the second set of symbols. In some examples, the coded bits 450-a may include shaped information bits as well as a second set of parity bits. The shaped information may be split into two different subsets of the bits. In some examples, the shaped information bits may include uₒ and u₁. uₒ may represent the high reliability bits (or MSBs) and u₁ may represent the other bits. In some examples, uₒ may be shaped according to a constellation shaping operation used at the transmitting device.

After demodulation, the coded bits 450-a may proceed to a deinterleaver 425-a and then to an ECD 420-a to undergo a second ECD operation. The ECD 420-a may utilize the second set of parity bits to determine whether the shaped information bits include one or more error and if the ECD 420-a determines the shaped information bits include one or more errors, the ECD 420-a may potentially correct the one or more errors. The ECD 420-a may output the shaped information bits. The shaped uₒ may be XOR'd with v while u₁ may proceed to the CRC check 405-a. XORing the shaped uₒ with v may deshape uₒ or undue the shaping operation performed on uₒ at the transmitter side.

After applying the Boolean function to the shaped uₒ and v, the transmitting device may perform the CRC check 405-a on the set of information bits 440 (e.g., uₒ and u₁). During the CRC check 405-a, the receiving device may analyze the CRC bits of the set of information bits 440 (e.g., CRC bits appended during transmission) to determine whether the set of information bits include any errors. If there are no errors, the set of information bits 440 may be successfully received by the receiving device.

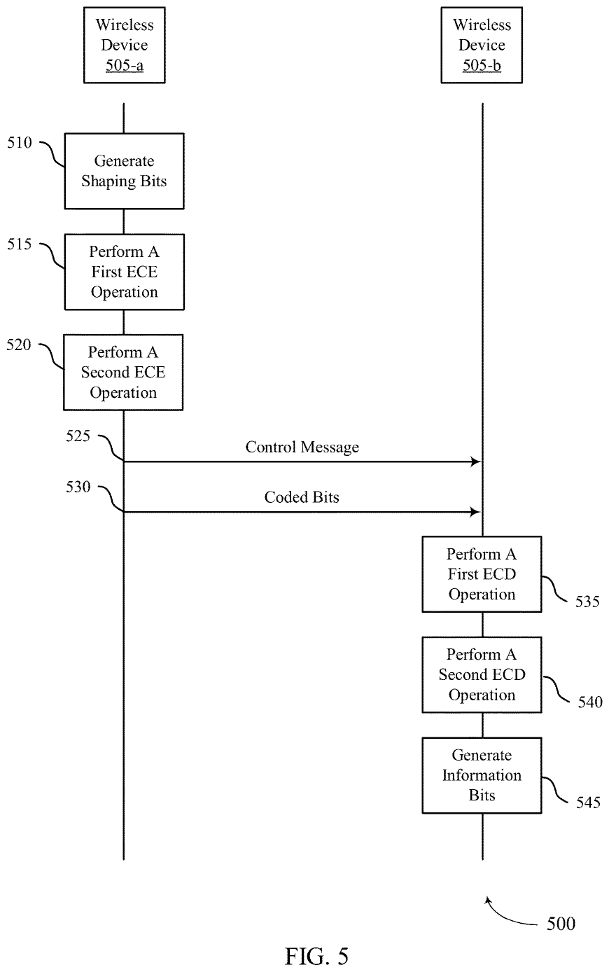

FIG. 5 shows an example of a process flow 500 that supports encoding schemes for wireless communications systems that support constellation shaping in accordance with one or more aspects of the present disclosure. In some examples, the process flow 500 may be implemented by aspects of a wireless communications system 100, a wireless communications system 200, a transmitter component diagram 300, and a receiver component diagram 400. For example, the process flow 500 may be implemented by wireless devices 505 which may be an example of UEs 115, network entities 105, or wireless devices 205 as described with reference to FIGS. 1 and 2. Alternative examples of the following may be implemented, where some steps are performed in a different order than described or are not performed at all. In some cases, steps may include additional features not mentioned below, or further steps may be added.

At 510, the wireless device 505-a may generate a set of shaping bits. In some examples, the wireless device 505-a may perform a constellation shaping operation on a set of information bits to generate the set of shaping bits. Further, the constellation shaping operation may shape the set of information bits resulting in shaped information bits. As described in FIG. 3, performing the constellation shaping operation may include inputting the set of information bits into a block decoder to generate the set of shaping bits, inputting the set of shaping bits into a block encoder to generate a set of output bits, and applying a Boolean function to the set of information bits and the set of output bits to generate a third set of bits (e.g., the shaped information bits). A code type associated with the block encoder may be polar code, hamming code, BCH code, Reed-Solomon code, or LDPC code.

In some examples, the wireless device 505-a may receive a control signal indicating an MCS table. The MCS table may include an indication of a set of coding rates associated with the constellation shaping operation. Further, the wireless device 505-a may receive a control signal that includes an index to the MCS table that identifies a coding rate of the set of coding rates that is applied to the constellation shaping operation. In some examples, the wireless device 505-a may input the set of shaping bits into a CRC encoder to generate a set of CRC bits.

The coding rate indicated in the MCS table may determine a number of shaping bits included in the set of shaping bits. For example, the number of shaping bits may be equal to the coding rate multiplied by a number of information bits included in the set of information bits (e.g., s=u*R, where s is the number of shaping bits, u is the number of information bits to be shaped, and R is the coding rate). A number of information bits included in the set of information bits may be equal to double the number of modulated symbols and a number of output bits included in the set of output bits may be equal to the number of information bits to be shaped (e.g., v=u_{shaped}, where v is the number of output bits).

In some examples, the coding rate may be included in a same MCS table used for other coding rates (e.g., coding rates for an LDPC encoder) because the coding rates associated with the constellation shaping operation may be related to SNR in a similar way that other coding rates are related to SNR. In such example, a column may be added to the MCS table specifying coding rates associated with constellation shaping.

At 515, the wireless device 505-a may perform a first ECE operation on the set of shaping bits to generate a first set of coded bits according to a first coding rate. The first coding rate may be a ratio between the number of shaping bits and the total number of coded bits included in the first set of coded bits. Thus, the number of coded bits included in the first set of coded bits may depend on the first coding rate. The first set of coded bits may include the set of shaping bits, a first set of parity bits, and the set of CRC bits.

Further, at 520, the wireless device 505-a may perform a second ECE operation on the set of information bits (e.g., the shaped information bits) according to a second coding rate. The second coding rate may be a ratio between the number of information bits and the total number of coded bits included in the second set of coded bits. Thus, the number of coded bits included in the second set of coded bits may depend on the second coding rate. The second set of coded bits may include the set of information bits (e.g., the shaped information bits) and a second set of parity bits. In some examples, a code type associated with the first ECE operation may include polar code and the code type associated with the second ECE operation may include LPDC code.

In some examples, after performing the first ECE operation and the second ECE operation, the wireless device 505-a may modulate the first set of coded bits and the second set of coded bits. A first modulation scheme for the first set of coded bits and a second modulation scheme for the second set of coded bits may be different. For example, the first modulation scheme for the first set of coded bits may be associated with a lower modulation order when compared to a modulation order associated with the second modulation scheme for the second set of coded bits.

In some examples, the wireless device 505-a may map the first set of coded bits to a first set of consecutive REs according to a first resource mapping (e.g., a first resource mapping within the PUSCH/PDSCH resource allocation, corresponding to coded shaping bits 210) and the second set of coded bits to a second set of consecutive set of REs different from the first set of consecutive REs according to a second resource mapping (e.g., a second resource mapping within the PUSCH/PDSCH resource allocation, corresponding to coded information bits 230). The first set of REs and the second set of REs may collectivity make up a resource allocation (e.g., a PUSCH or PDSCH resource allocation). In some examples, the wireless device 505-a may map the first set of coded bits to the first set of consecutive REs using a frequency-first, timing-second mapping scheme and after mapping the first set of coded bits, the wireless device 505-a may map the second set of coded bits to the second set of consecutive REs using the frequency first, timing second mapping scheme. That is, the wireless device 505-a may map the first set of coded bits to a first number of REs of the resource allocation and then map the second set of coded bits to the remaining REs of the resource allocation.

At 525, the wireless device 505-a may transmit one or more control messages (e.g., DCI, RRC, or a MAC-CE) to the wireless device 505-b. The one or more control messages may indicate the resource allocation and an offset that identifies the first resource mapping and the second resource mapping. In some examples, the indication of the resource allocation and the indication of the offset may be transmitted via different control message. The offset may be associated with the first coding rate and the second coding rate. For example, the offset may be a difference between the coding rate of the set of information bits and the coding rate for the set of shaping bits. Using the offset (along with other information such as TB size), the wireless device 505-b may determine a number of REs of the resource allocation that will be used to transmit the first set of coded bits.

At 530, the wireless device 505-a may transmit the first set of coded bits and the second set of coded bits to the wireless device 505-b. In some examples, the wireless device 505-a may transmit the first set of coded bits using the first set of REs and the second set of coded bits using the second set of REs.

In some examples, after receiving the first set of coded bits and the second set of coded bits, the wireless device 505-b may demodulate the first set of coded bits and the second set of coded bits according to the first modulation scheme and the set modulation scheme.

At 535, the wireless device 505-b may perform a first ECD operation on the first set of coded bits to generate the set of shaping bits. In some examples, the wireless device 505-b may generate the set of shaping bits using a CRC decoder (e.g., by inputting the first set of coded bits into the CRC decoder). Further, at 540, the wireless device 505-a may perform a second ECD operation on the second set of coded bits to generate a set of decoded bits (e.g., shaped information bits).

At 545, the wireless device 505-b may generate the set of information bits. In some examples, the wireless device 505-b may perform a constellation deshaping operation on the set of decoded bits to generate the set of information bits. Performing the constellation shaping operation may include inputting the set of shaping bits into a block encoder to generate a set of output bits and applying a Boolean function to the set of decoded bits and the set of output bits to generate the set of information bits.

In some examples, the wireless device 505-b may transmit a feedback message (e.g., HARQ feedback) to the wireless device 505-a indicating whether one or both of the first set of coded bits or the second set of coded bits was successfully received and decoded by the wireless device 505-b. The feedback message may include a set of one or more bits. As one example, the set may include a single bits and a logic value of the single bits may indicate if the second set of coded bits were successfully received (e.g., acknowledgement (ACK)) or the second set of coded bits were unsuccessfully received (e.g., negative acknowledgement (NACK)).

In another example, the set of bits may include two bits and the collective logic values of the two bits may indicate whether one or both of the first set of coded bits or the second set of coded bits were successfully received. For example, if the logic value of the two bits is 00, the wireless device 505-a may determine that both the first set of coded bits and the second set of coded bits were not received successfully. Alternatively, if the logic value of the two bits is 01, the wireless device 505-a may determine that the second set of coded bits were not received successfully and the first set of coded bits were received successfully. In such case, the wireless device 505-a may not retransmit the first set of coded bits to save resources. In another example, if the logic value of the two bits is 10, the wireless device 505-a may determine that the second set of coded bits were received successfully. The logic value of 11 may be reserved bits.

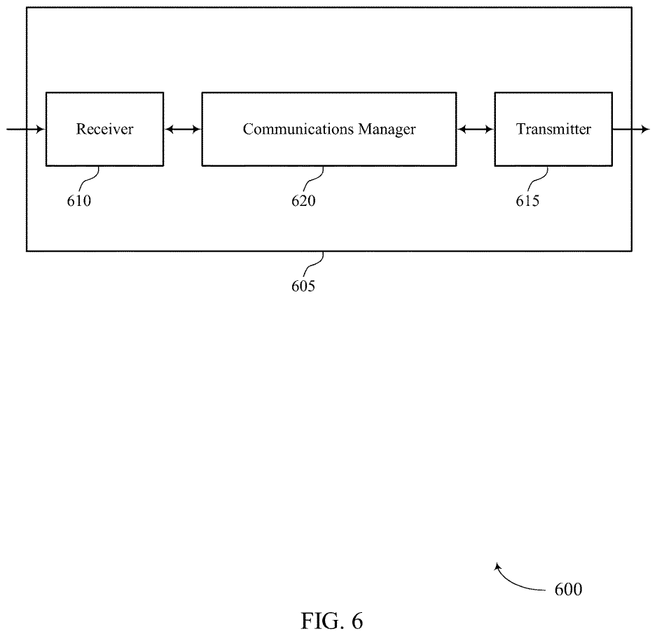

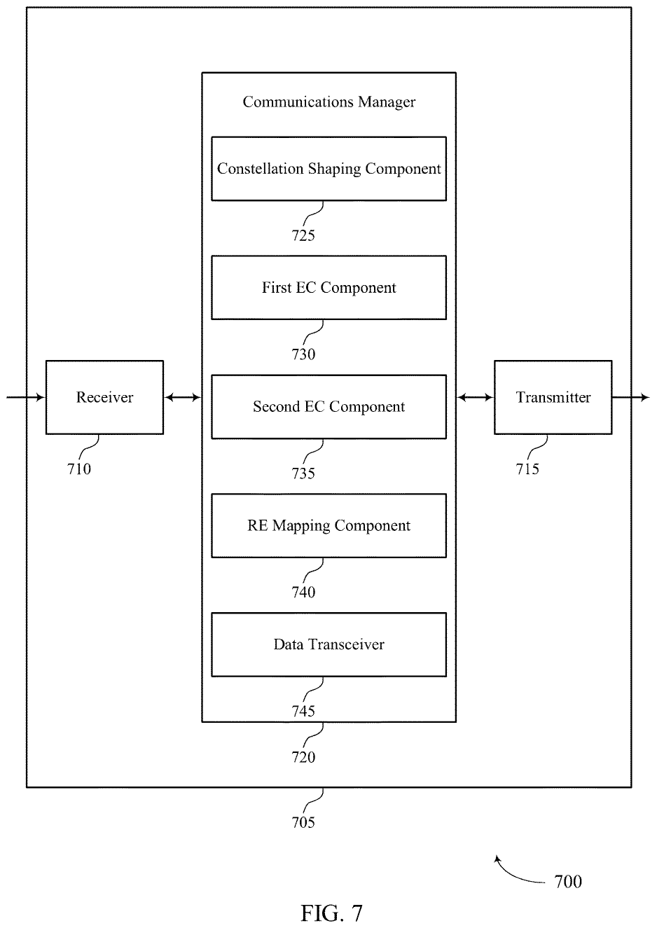

FIG. 6 shows a block diagram 600 of a device 605 that supports encoding schemes for wireless communications systems that support constellation shaping in accordance with one or more aspects of the present disclosure. The device 605 may be an example of aspects of a UE 115 or a network entity 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to encoding schemes for wireless communications systems that support constellation shaping). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to encoding schemes for wireless communications systems that support constellation shaping). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of encoding schemes for wireless communications systems that support constellation shaping as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a wireless device in accordance with examples as disclosed herein. For example, the communications manager 620 is capable of, configured to, or operable to support a means for generating a set of shaping bits based on performing a constellation shaping operation on a set of information bits. The communications manager 620 is capable of, configured to, or operable to support a means for performing, based on the set of shaping bits, a first error correction encoding operation according to a first coding rate to generate a first set of coded bits. The communications manager 620 is capable of, configured to, or operable to support a means for performing, based on the set of information bits, a second error correction encoding operation according to a second coding rate to generate a second set of coded bits. The communications manager 620 is capable of, configured to, or operable to support a means for transmitting at least one control message indicating a resource allocation and an offset that identifies a first resource mapping within the resource allocation for the first set of coded bits and a second resource mapping within the resource allocation for the second set of coded bits, the offset corresponding to the first coding rate and the second coding rate. The communications manager 620 is capable of, configured to, or operable to support a means for transmitting, via the resource allocation, the first set of coded bits in accordance with the first resource mapping and the second set of coded bits in accordance with the second resource mapping based on the at least one control message.

Additionally, or alternatively, the communications manager 620 may support wireless communication at a wireless device in accordance with examples as disclosed herein. For example, the communications manager 620 is capable of, configured to, or operable to support a means for receiving at least one control message indicating a resource allocation and an offset that identifies a first resource mapping within the resource allocation for a first set of coded bits and a second resource mapping within the resource allocation for a second set of coded bits, the offset corresponding to a first coding rate associated with the first set of coded bits and a second coding rate associated with the second set of coded bits. The communications manager 620 is capable of, configured to, or operable to support a means for receiving, via the resource allocation, the first set of coded bits in accordance with the first resource mapping and the second set of coded bits in accordance with the second resource mapping based on the at least one control message. The communications manager 620 is capable of, configured to, or operable to support a means for performing, based on the first set of coded bits, a first error correction decoding operation to generate a set of shaping bits. The communications manager 620 is capable of, configured to, or operable to support a means for performing, based on the second set of coded bits, a second error correction decoding operation to generate a set of decoded bits. The communications manager 620 is capable of, configured to, or operable to support a means for generating, based on the set of decoded bits and the set of shaping bits and using a constellation deshaping operation, a set of information bits.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced power consumption and more efficient utilization of communication resources.

FIG. 7 shows a block diagram 700 of a device 705 that supports encoding schemes for wireless communications systems that support constellation shaping in accordance with one or more aspects of the present disclosure. The device 705 may be an example of aspects of a device 605, a UE 115, or a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to encoding schemes for wireless communications systems that support constellation shaping). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to encoding schemes for wireless communications systems that support constellation shaping). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of encoding schemes for wireless communications systems that support constellation shaping as described herein. For example, the communications manager 720 may include a constellation shaping component 725, a first EC component 730, a second EC component 735, a RE mapping component 740, a data transceiver 745, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a wireless device in accordance with examples as disclosed herein. The constellation shaping component 725 is capable of, configured to, or operable to support a means for generating a set of shaping bits based on performing a constellation shaping operation on a set of information bits. The first EC component 730 is capable of, configured to, or operable to support a means for performing, based on the set of shaping bits, a first error correction encoding operation according to a first coding rate to generate a first set of coded bits. The second EC component 735 is capable of, configured to, or operable to support a means for performing, based on the set of information bits, a second error correction encoding operation according to a second coding rate to generate a second set of coded bits. The RE mapping component 740 is capable of, configured to, or operable to support a means for transmitting at least one control message indicating a resource allocation and an offset that identifies a first resource mapping within the resource allocation for the first set of coded bits and a second resource mapping within the resource allocation for the second set of coded bits, the offset corresponding to the first coding rate and the second coding rate. The data transceiver 745 is capable of, configured to, or operable to support a means for transmitting, via the resource allocation, the first set of coded bits in accordance with the first resource mapping and the second set of coded bits in accordance with the second resource mapping based on the at least one control message.

Additionally, or alternatively, the communications manager 720 may support wireless communication at a wireless device in accordance with examples as disclosed herein. The RE mapping component 740 is capable of, configured to, or operable to support a means for receiving at least one control message indicating a resource allocation and an offset that identifies a first resource mapping within the resource allocation for a first set of coded bits and a second resource mapping within the resource allocation for a second set of coded bits, the offset corresponding to a first coding rate associated with the first set of coded bits and a second coding rate associated with the second set of coded bits. The data transceiver 745 is capable of, configured to, or operable to support a means for receiving, via the resource allocation, the first set of coded bits in accordance with the first resource mapping and the second set of coded bits in accordance with the second resource mapping based on the at least one control message. The first EC component 730 is capable of, configured to, or operable to support a means for performing, based on the first set of coded bits, a first error correction decoding operation to generate a set of shaping bits. The second EC component 735 is capable of, configured to, or operable to support a means for performing, based on the second set of coded bits, a second error correction decoding operation to generate a set of decoded bits. The constellation shaping component 725 is capable of, configured to, or operable to support a means for generating, based on the set of decoded bits and the set of shaping bits and using a constellation deshaping operation, a set of information bits.

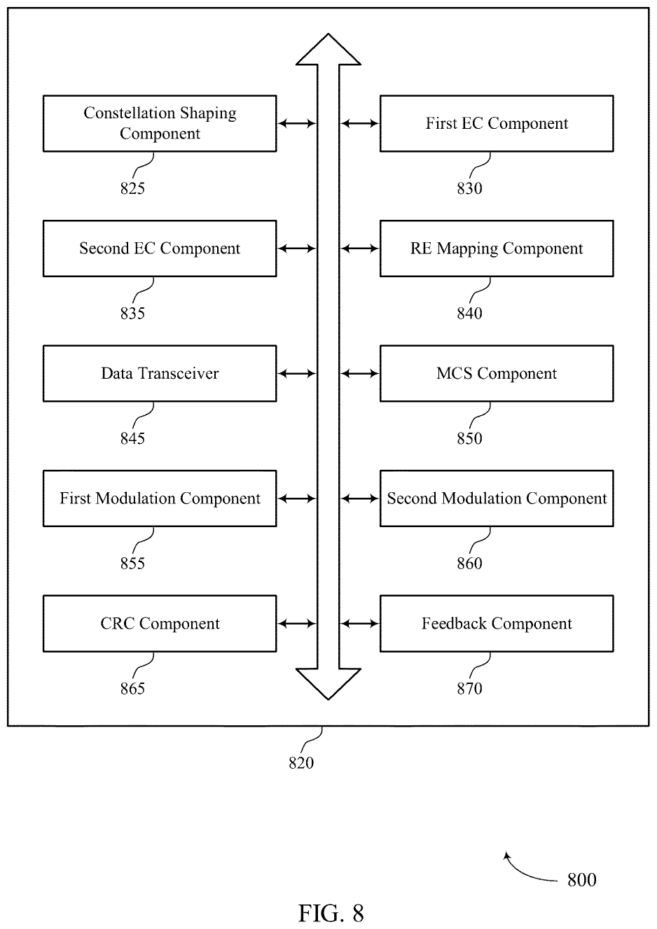

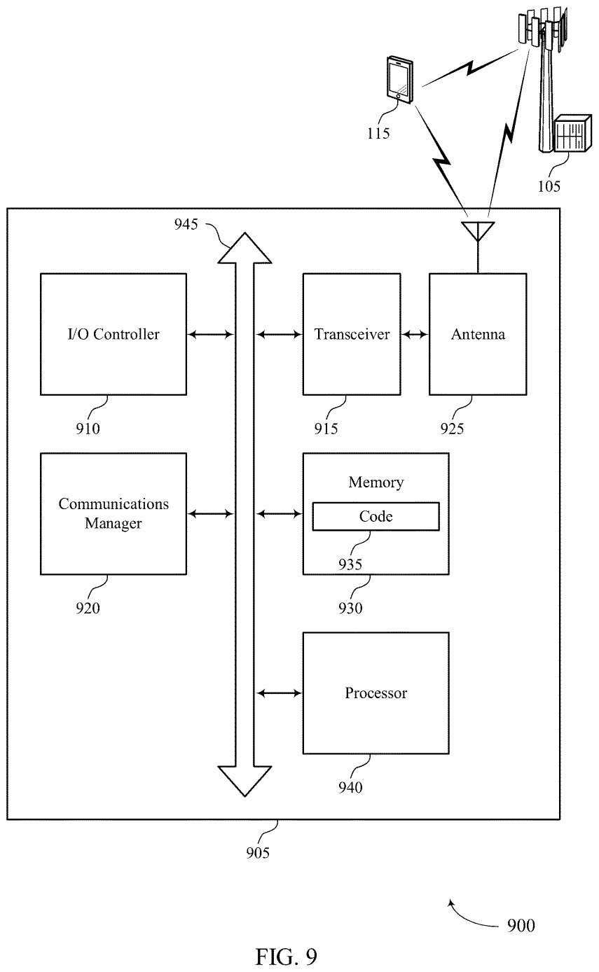

FIG. 8 shows a block diagram 800 of a communications manager 820 that supports encoding schemes for wireless communications systems that support constellation shaping in accordance with one or more aspects of the present disclosure. The communications manager 820 may be an example of aspects of a communications manager 620, a communications manager 720, or both, as described herein. The communications manager 820, or various components thereof, may be an example of means for performing various aspects of encoding schemes for wireless communications systems that support constellation shaping as described herein. For example, the communications manager 820 may include a constellation shaping component 825, a first EC component 830, a second EC component 835, a RE mapping component 840, a data transceiver 845, an MCS component 850, a first modulation component 855, a second modulation component 860, an CRC component 865, a feedback component 870, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communication at a wireless device in accordance with examples as disclosed herein. The constellation shaping component 825 is capable of, configured to, or operable to support a means for generating a set of shaping bits based on performing a constellation shaping operation on a set of information bits. The first EC component 830 is capable of, configured to, or operable to support a means for performing, based on the set of shaping bits, a first error correction encoding operation according to a first coding rate to generate a first set of coded bits. The second EC component 835 is capable of, configured to, or operable to support a means for performing, based on the set of information bits, a second error correction encoding operation according to a second coding rate to generate a second set of coded bits. The RE mapping component 840 is capable of, configured to, or operable to support a means for transmitting at least one control message indicating a resource allocation and an offset that identifies a first resource mapping within the resource allocation for the first set of coded bits and a second resource mapping within the resource allocation for the second set of coded bits, the offset corresponding to the first coding rate and the second coding rate. The data transceiver 845 is capable of, configured to, or operable to support a means for transmitting, via the resource allocation, the first set of coded bits in accordance with the first resource mapping and the second set of coded bits in accordance with the second resource mapping based on the at least one control message.

In some examples, to support transmitting the at least one control message, the RE mapping component 840 is capable of, configured to, or operable to support a means for transmitting a first control message indicating the offset. In some examples, to support transmitting the at least one control message, the RE mapping component 840 is capable of, configured to, or operable to support a means for transmitting a second control message indicating the resource allocation.

In some examples, to support transmitting the at least one control message, the MCS component 850 is capable of, configured to, or operable to support a means for transmitting a first control message indicating a MCS table, where the MCS table includes an indication of a set of multiple coding rates associated with the set of shaping bits. In some examples, to support transmitting the at least one control message, the MCS component 850 is capable of, configured to, or operable to support a means for transmitting a second control message including an index to the MCS table that identifies a third coding rate of the set of multiple coding rates that is applied during the constellation shaping operation.

In some examples, the RE mapping component 840 is capable of, configured to, or operable to support a means for mapping the first set of coded bits to a first set of consecutive REs according to the first resource mapping and the second set of coded bits to a second set of consecutive REs different from the first set of consecutive REs according to the second resource mapping, where the resource allocation includes the first set of consecutive REs and the second set of consecutive REs.

In some examples, to support mapping the first set of coded bits and the second set of coded bits, the RE mapping component 840 is capable of, configured to, or operable to support a means for mapping the first set of coded bits to the first set of consecutive REs using a frequency-first, time-second mapping scheme. In some examples, to support mapping the first set of coded bits and the second set of coded bits, the RE mapping component 840 is capable of, configured to, or operable to support a means for mapping, after mapping the first set of coded bits, the second set of coded bits to the second set of consecutive REs using the frequency-first, time-second mapping scheme.

In some examples, to support transmitting the first set of coded bits and the second set of coded bits, the data transceiver 845 is capable of, configured to, or operable to support a means for transmitting the first set of coded bits using the first set of consecutive REs. In some examples, to support transmitting the first set of coded bits and the second set of coded bits, the data transceiver 845 is capable of, configured to, or operable to support a means for transmitting the second set of coded bits using the second set of consecutive REs. In some examples, the offset identifies a relationship between the first coding rate and the second coding rate.

In some examples, the first modulation component 855 is capable of, configured to, or operable to support a means for modulating the first set of coded bits using a first modulation scheme. In some examples, the second modulation component 860 is capable of, configured to, or operable to support a means for modulating the second set of coded bits using a second modulation scheme, where a modulation order associated with the first modulation scheme is smaller than a modulation order associated with the second modulation scheme.

In some examples, to support performing the constellation shaping operation, the constellation shaping component 825 is capable of, configured to, or operable to support a means for inputting the set of information bits to a block decoder to generate the set of shaping bits. In some examples, to support performing the constellation shaping operation, the constellation shaping component 825 is capable of, configured to, or operable to support a means for inputting the set of shaping bits into a block encoder to generate a set of output bits. In some examples, to support performing the constellation shaping operation, the constellation shaping component 825 is capable of, configured to, or operable to support a means for applying a Boolean function to the set of information bits and the set of output bits to generate a third set of bits, where the second set of coded bits are generated based on performing the second error correction encoding operation to the third set of bits according to the second coding rate.

In some examples, a code type associated with the block encoder or the block decoder includes polar code, Hamming code, BCH code, Reed-Solomon code, or LDPC code.

In some examples, the CRC component 865 is capable of, configured to, or operable to support a means for inputting the set of shaping bits into a CRC encoder to generate a set of CRC bits, where the first set of coded bits includes the set of CRC bits.

In some examples, the feedback component 870 is capable of, configured to, or operable to support a means for receiving a feedback message indicating whether one or both of the first set of coded bits or the second set of coded bits were decoded successfully.

In some examples, to support transmitting the at least one control message, the RE mapping component 840 is capable of, configured to, or operable to support a means for transmitting an RRC message, DCI, a MAC-CE, or a combination thereof, where the RRC message, the DCI, or the MAC-CE indicates one or both of the resource allocation or the offset.

In some examples, a code type associated with the first error correction encoding operation is different than a code type associated with the second error correction encoding operation.

In some examples, the code type associated with the first error correction encoding operation includes polar code and the code type associated with the second error correction encoding operation includes LDPC code.

Additionally, or alternatively, the communications manager 820 may support wireless communication at a wireless device in accordance with examples as disclosed herein. In some examples, the RE mapping component 840 is capable of, configured to, or operable to support a means for receiving at least one control message indicating a resource allocation and an offset that identifies a first resource mapping within the resource allocation for a first set of coded bits and a second resource mapping within the resource allocation for a second set of coded bits, the offset corresponding to a first coding rate associated with the first set of coded bits and a second coding rate associated with the second set of coded bits. In some examples, the data transceiver 845 is capable of, configured to, or operable to support a means for receiving, via the resource allocation, the first set of coded bits in accordance with the first resource mapping and the second set of coded bits in accordance with the second resource mapping based on the at least one control message. In some examples, the first EC component 830 is capable of, configured to, or operable to support a means for performing, based on the first set of coded bits, a first error correction decoding operation to generate a set of shaping bits. In some examples, the second EC component 835 is capable of, configured to, or operable to support a means for performing, based on the second set of coded bits, a second error correction decoding operation to generate a set of decoded bits. In some examples, the constellation shaping component 825 is capable of, configured to, or operable to support a means for generating, based on the set of decoded bits and the set of shaping bits and using a constellation deshaping operation, a set of information bits.

In some examples, to support receiving the at least one control message, the RE mapping component 840 is capable of, configured to, or operable to support a means for receiving a first control message indicating the offset. In some examples, to support receiving the at least one control message, the RE mapping component 840 is capable of, configured to, or operable to support a means for receiving a second control message indicating the resource allocation.

In some examples, to support receiving the at least one control message, the RE mapping component 840 is capable of, configured to, or operable to support a means for receiving an RRC message, DCI, a MAC-CE, or a combination thereof, where the RRC message, the DCI, or the MAC-CE indicates one or both of the resource allocation or the offset.

In some examples, to support receiving the first set of coded bits and the second set of coded bits, the data transceiver 845 is capable of, configured to, or operable to support a means for receiving the first set of coded bits using a first set of consecutive REs according to the first resource mapping. In some examples, to support receiving the first set of coded bits and the second set of coded bits, the data transceiver 845 is capable of, configured to, or operable to support a means for receiving the second set of coded bits using a second set of consecutive REs different than the first set of consecutive REs according to the second resource mapping, where the resource allocation includes the first set of consecutive REs and the second set of consecutive REs.

In some examples, the RE mapping component 840 is capable of, configured to, or operable to support a means for determining a number of REs included in the first set of consecutive REs based on the offset.

In some examples, to support receiving the at least one control message, the MCS component 850 is capable of, configured to, or operable to support a means for receiving a first control message indicating a MCS table, where the MCS table includes an indication of a set of multiple coding rates associated with the set of shaping bits. In some examples, to support receiving the at least one control message, the MCS component 850 is capable of, configured to, or operable to support a means for receiving a second control message including an index to the MCS table that identifies a third coding rate of the set of multiple coding rates that is applied during a constellation shaping operation.

In some examples, the first modulation component 855 is capable of, configured to, or operable to support a means for demodulating the first set of coded bits using a first modulation scheme. In some examples, the second modulation component 860 is capable of, configured to, or operable to support a means for demodulating the second set of coded bits using a second modulation scheme, where a modulation order associated with the first modulation scheme is smaller than a modulation order associated with the second modulation scheme.

In some examples, to support performing the constellation deshaping operation, the constellation shaping component 825 is capable of, configured to, or operable to support a means for inputting the set of shaping bits into a block encoder to generate a set of output bits. In some examples, to support performing the constellation deshaping operation, the constellation shaping component 825 is capable of, configured to, or operable to support a means for applying a Boolean function to the set of decoded bits and the set of output bits to generate the set of information bits.

In some examples, a code type associated with the block encoder includes polar code, hamming code, BCH code, Reed-Solomon code, or LDPC code.

In some examples, the first set of coded bits includes a set of cyclic redundancy bits, and the CRC component 865 is capable of, configured to, or operable to support a means for generating, based on the first set of coded bits, the set of shaping bits using a CRC decoder.

In some examples, the feedback component 870 is capable of, configured to, or operable to support a means for transmitting a feedback message indicating whether one or both of the first set of coded bits or the second set of coded bits were decoded successfully. In some examples, the offset identifies a relationship between the first coding rate and the second coding rate.

In some examples, a code type associated with the first error correction decoding operation is different than a code type associated with the second error correction decoding operation.

In some examples, the code type associated with the first error correction decoding operation includes polar code and the code type associated with the second error correction decoding operation includes LDPC code.

FIG. 9 shows a diagram of a system 900 including a device 905 that supports encoding schemes for wireless communications systems that support constellation shaping in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting encoding schemes for wireless communications systems that support constellation shaping). For example, the device 905 or a component of the device 905 may include a processor 940 and memory 930 coupled with or to the processor 940, the processor 940 and memory 930 configured to perform various functions described herein.

The communications manager 920 may support wireless communication at a wireless device in accordance with examples as disclosed herein. For example, the communications manager 920 is capable of, configured to, or operable to support a means for generating a set of shaping bits based on performing a constellation shaping operation on a set of information bits. The communications manager 920 is capable of, configured to, or operable to support a means for performing, based on the set of shaping bits, a first error correction encoding operation according to a first coding rate to generate a first set of coded bits. The communications manager 920 is capable of, configured to, or operable to support a means for performing, based on the set of information bits, a second error correction encoding operation according to a second coding rate to generate a second set of coded bits. The communications manager 920 is capable of, configured to, or operable to support a means for transmitting at least one control message indicating a resource allocation and an offset that identifies a first resource mapping within the resource allocation for the first set of coded bits and a second resource mapping within the resource allocation for the second set of coded bits, the offset corresponding to the first coding rate and the second coding rate. The communications manager 920 is capable of, configured to, or operable to support a means for transmitting, via the resource allocation, the first set of coded bits in accordance with the first resource mapping and the second set of coded bits in accordance with the second resource mapping based on the at least one control message.

Additionally, or alternatively, the communications manager 920 may support wireless communication at a wireless device in accordance with examples as disclosed herein. For example, the communications manager 920 is capable of, configured to, or operable to support a means for receiving at least one control message indicating a resource allocation and an offset that identifies a first resource mapping within the resource allocation for a first set of coded bits and a second resource mapping within the resource allocation for a second set of coded bits, the offset corresponding to a first coding rate associated with the first set of coded bits and a second coding rate associated with the second set of coded bits. The communications manager 920 is capable of, configured to, or operable to support a means for receiving, via the resource allocation, the first set of coded bits in accordance with the first resource mapping and the second set of coded bits in accordance with the second resource mapping based on the at least one control message. The communications manager 920 is capable of, configured to, or operable to support a means for performing, based on the first set of coded bits, a first error correction decoding operation to generate a set of shaping bits. The communications manager 920 is capable of, configured to, or operable to support a means for performing, based on the second set of coded bits, a second error correction decoding operation to generate a set of decoded bits. The communications manager 920 is capable of, configured to, or operable to support a means for generating, based on the set of decoded bits and the set of shaping bits and using a constellation deshaping operation, a set of information bits.

By including or configuring the communications manager 920 in accordance with examples as described herein, the device 905 may support techniques for reduced latency, reduced power consumption, and more efficient utilization of communication resources.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of encoding schemes for wireless communications systems that support constellation shaping as described herein, or the processor 940 and the memory 930 may be otherwise configured to perform or support such operations.

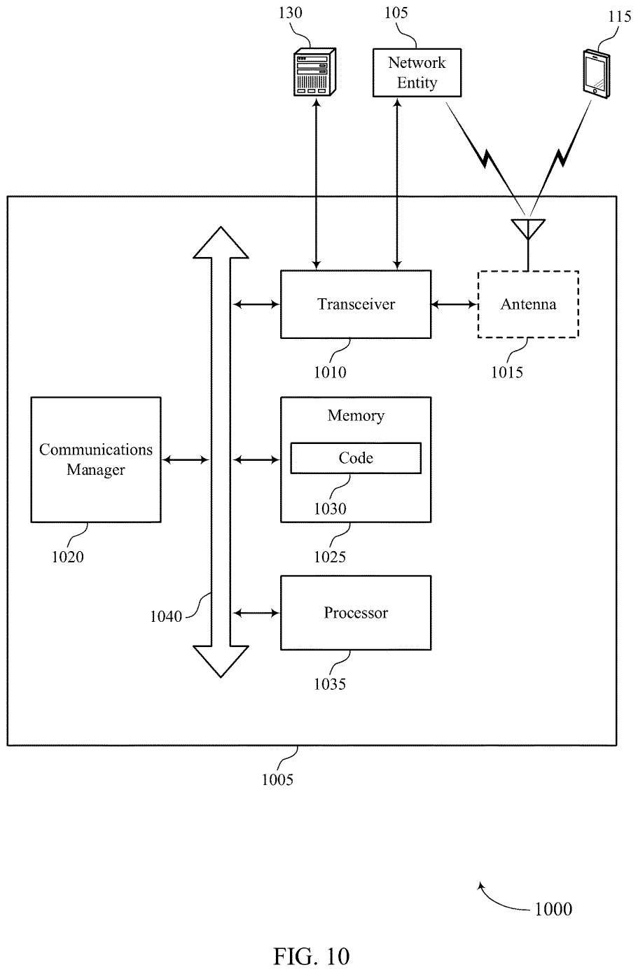

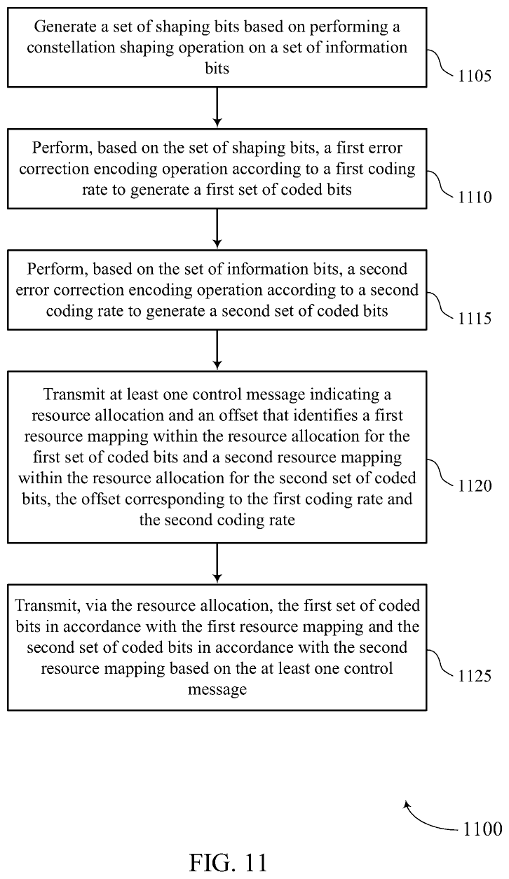

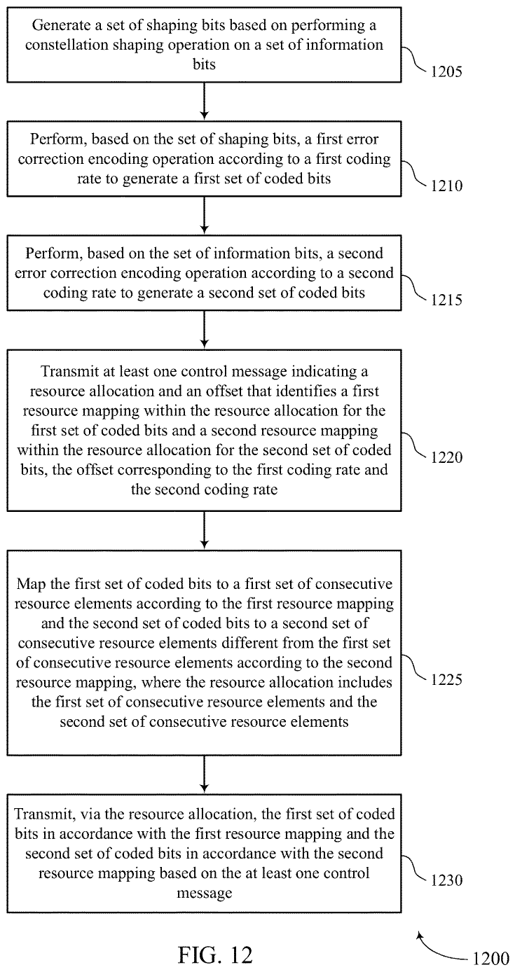

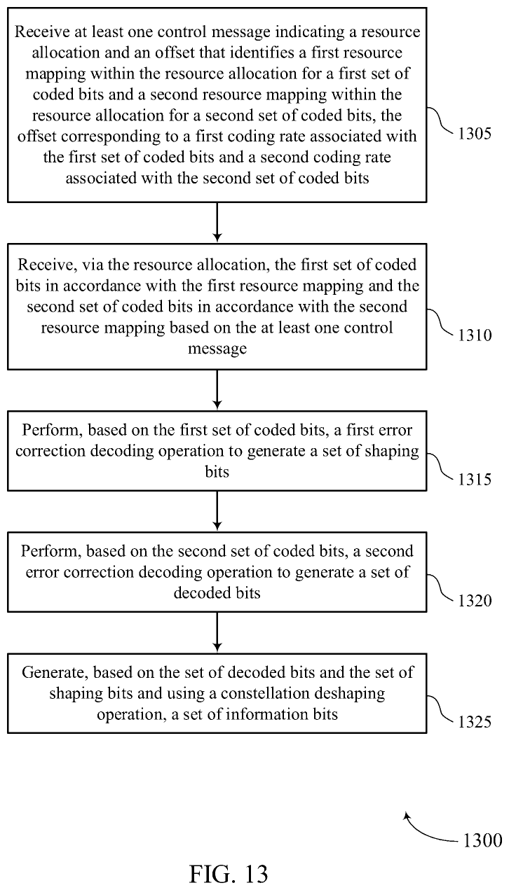

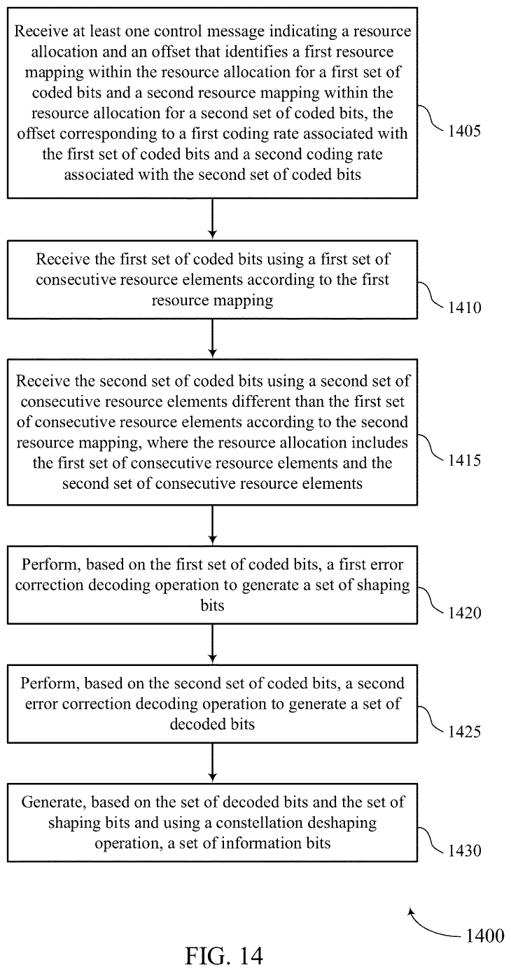

FIG. 10 shows a diagram of a system 1000 including a device 1005 that supports encoding schemes for wireless communications systems that support constellation shaping in accordance with one or more aspects of the present disclosure. The device 1005 may be an example of or include the components of a device 605, a device 705, or a network entity 105 as described herein. The device 1005 may communicate with one or more network entities 105, one or more UEs 115, or any combination thereof, which may include communications over one or more wired interfaces, over one or more wireless interfaces, or any combination thereof. The device 1005 may include components that support outputting and obtaining communications, such as a communications manager 1020, a transceiver 1010, an antenna 1015, a memory 1025, code 1030, and a processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or memory components (for example, the processor 1035, or the memory 1025, or both), may be included in a chip or chip assembly that is installed in the device 1005. In some examples, the transceiver may be operable to support communications via one or more communications links (e.g., a communication link 125, a backhaul communication link 120, a midhaul communication link 162, a fronthaul communication link 168).

The memory 1025 may include RAM and ROM. The memory 1025 may store computer-readable, computer-executable code 1030 including instructions that, when executed by the processor 1035, cause the device 1005 to perform various functions described herein. The code 1030 may be stored in a non-transitory computer-readable medium such as system memory or another type of memory. In some cases, the code 1030 may not be directly executable by the processor 1035 but may cause a computer (e.g., when compiled and executed) to perform functions described herein. In some cases, the memory 1025 may contain, among other things, a BIOS which may control basic hardware or software operation such as the interaction with peripheral components or devices.

The processor 1035 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1035 may be configured to operate a memory array using a memory controller. In some other cases, a memory controller may be integrated into the processor 1035. The processor 1035 may be configured to execute computer-readable instructions stored in a memory (e.g., the memory 1025) to cause the device 1005 to perform various functions (e.g., functions or tasks supporting encoding schemes for wireless communications systems that support constellation shaping). For example, the device 1005 or a component of the device 1005 may include a processor 1035 and memory 1025 coupled with the processor 1035, the processor 1035 and memory 1025 configured to perform various functions described herein. The processor 1035 may be an example of a cloud-computing platform (e.g., one or more physical nodes and supporting software such as operating systems, virtual machines, or container instances) that may host the functions (e.g., by executing code 1030) to perform the functions of the device 1005. The processor 1035 may be any one or more suitable processors capable of executing scripts or instructions of one or more software programs stored in the device 1005 (such as within the memory 1025). In some implementations, the processor 1035 may be a component of a processing system. A processing system may generally refer to a system or series of machines or components that receives inputs and processes the inputs to produce a set of outputs (which may be passed to other systems or components of, for example, the device 1005). For example, a processing system of the device 1005 may refer to a system including the various other components or subcomponents of the device 1005, such as the processor 1035, or the transceiver 1010, or the communications manager 1020, or other components or combinations of components of the device 1005. The processing system of the device 1005 may interface with other components of the device 1005, and may process information received from other components (such as inputs or signals) or output information to other components. For example, a chip or modem of the device 1005 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1005 may transmit information output from the chip or modem. Additionally, or alternatively, in some implementations, the one or more interfaces may refer to an interface between the processing system of the chip or modem and a receiver, such that the device 1005 may obtain information or signal inputs, and the information may be passed to the processing system. A person having ordinary skill in the art will readily recognize that a first interface also may obtain information or signal inputs, and a second interface also may output information or signal outputs.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the communications manager 1020, the transceiver 1010, the memory 1025, the code 1030, and the processor 1035 may be located in one of the different components or divided between different components).

In some examples, the communications manager 1020 may manage aspects of communications with a core network 130 (e.g., via one or more wired or wireless backhaul links). For example, the communications manager 1020 may manage the transfer of data communications for client devices, such as one or more UEs 115. In some examples, the communications manager 1020 may manage communications with other network entities 105, and may include a controller or scheduler for controlling communications with UEs 115 in cooperation with other network entities 105. In some examples, the communications manager 1020 may support an X2 interface within an LTE/LTE-A wireless communications network technology to provide communication between network entities 105.

The communications manager 1020 may support wireless communication at a wireless device in accordance with examples as disclosed herein. For example, the communications manager 1020 is capable of, configured to, or operable to support a means for generating a set of shaping bits based on performing a constellation shaping operation on a set of information bits. The communications manager 1020 is capable of, configured to, or operable to support a means for performing, based on the set of shaping bits, a first error correction encoding operation according to a first coding rate to generate a first set of coded bits. The communications manager 1020 is capable of, configured to, or operable to support a means for performing, based on the set of information bits, a second error correction encoding operation according to a second coding rate to generate a second set of coded bits. The communications manager 1020 is capable of, configured to, or operable to support a means for transmitting at least one control message indicating a resource allocation and an offset that identifies a first resource mapping within the resource allocation for the first set of coded bits and a second resource mapping within the resource allocation for the second set of coded bits, the offset corresponding to the first coding rate and the second coding rate. The communications manager 1020 is capable of, configured to, or operable to support a means for transmitting, via the resource allocation, the first set of coded bits in accordance with the first resource mapping and the second set of coded bits in accordance with the second resource mapping based on the at least one control message.

Additionally, or alternatively, the communications manager 1020 may support wireless communication at a wireless device in accordance with examples as disclosed herein. For example, the communications manager 1020 is capable of, configured to, or operable to support a means for receiving at least one control message indicating a resource allocation and an offset that identifies a first resource mapping within the resource allocation for a first set of coded bits and a second resource mapping within the resource allocation for a second set of coded bits, the offset corresponding to a first coding rate associated with the first set of coded bits and a second coding rate associated with the second set of coded bits. The communications manager 1020 is capable of, configured to, or operable to support a means for receiving, via the resource allocation, the first set of coded bits in accordance with the first resource mapping and the second set of coded bits in accordance with the second resource mapping based on the at least one control message. The communications manager 1020 is capable of, configured to, or operable to support a means for performing, based on the first set of coded bits, a first error correction decoding operation to generate a set of shaping bits. The communications manager 1020 is capable of, configured to, or operable to support a means for performing, based on the second set of coded bits, a second error correction decoding operation to generate a set of decoded bits. The communications manager 1020 is capable of, configured to, or operable to support a means for generating, based on the set of decoded bits and the set of shaping bits and using a constellation deshaping operation, a set of information bits.

By including or configuring the communications manager 1020 in accordance with examples as described herein, the device 1005 may support techniques for reduced latency, reduced power consumption, and more efficient utilization of communication resources.

In some examples, the communications manager 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the communications manager 1020 is illustrated as a separate component, in some examples, one or more functions described with reference to the communications manager 1020 may be supported by or performed by the transceiver 1010, the processor 1035, the memory 1025, the code 1030, or any combination thereof. For example, the code 1030 may include instructions executable by the processor 1035 to cause the device 1005 to perform various aspects of encoding schemes for wireless communications systems that support constellation shaping as described herein, or the processor 1035 and the memory 1025 may be otherwise configured to perform or support such operations.

FIG. 11 shows a flowchart illustrating a method 1100 that supports encoding schemes for wireless communications systems that support constellation shaping in accordance with aspects of the present disclosure. The operations of the method 1100 may be implemented by a UE or a network entity or its components as described herein. For example, the operations of the method 1100 may be performed by a UE 115 or a network entity as described with reference to FIGS. 1 through 10. In some examples, a UE or a network entity may execute a set of instructions to control the functional elements of the wireless UE or the wireless network entity to perform the described functions. Additionally, or alternatively, the wireless UE or the wireless network entity may perform aspects of the described functions using special-purpose hardware.

At 1105, the method may include generating a set of shaping bits based on performing a constellation shaping operation on a set of information bits. The operations of 1105 may be performed in accordance with examples as disclosed herein. In some examples, aspects of the operations of 1105 may be performed by a constellation shaping component 825 as described with reference to FIG. 8.

At 1110, the method may include performing, based on the set of shaping bits, a first error correction encoding operation according to a first coding rate to generate a first set of coded bits. The operations of 1110 may be performed in accordance with examples as disclosed herein. In some examples, aspects of the operations of 1110 may be performed by a first EC component 830 as described with reference to FIG. 8.

At 1115, the method may include performing, based on the set of information bits, a second error correction encoding operation according to a second coding rate to generate a second set of coded bits. The operations of 1115 may be performed in accordance with examples as disclosed herein. In some examples, aspects of the operations of 1115 may be performed by a second EC component 835 as described with reference to FIG. 8.

At 1120, the method may include transmitting at least one control message indicating a resource allocation and an offset that identifies a first resource mapping within the resource allocation for the first set of coded bits and a second resource mapping within the resource allocation for the second set of coded bits, the offset corresponding to the first coding rate and the second coding rate. The operations of 1120 may be performed in accordance with examples as disclosed herein. In some examples, aspects of the operations of 1120 may be performed by a RE mapping component 840 as described with reference to FIG. 8.

At 1125, the method may include transmitting, via the resource allocation, the first set of coded bits in accordance with the first resource mapping and the second set of coded bits in accordance with the second resource mapping based on the at least one control message. The operations of 1125 may be performed in accordance with examples as disclosed herein. In some examples, aspects of the operations of 1125 may be performed by a data transceiver 845 as described with reference to FIG. 8.

FIG. 12 shows a flowchart illustrating a method 1200 that supports encoding schemes for wireless communications systems that support constellation shaping in accordance with aspects of the present disclosure. The operations of the method 1200 may be implemented by a UE or a network entity or its components as described herein. For example, the operations of the method 1200 may be performed by a UE 115 or a network entity as described with reference to FIGS. 1 through 10. In some examples, a UE or a network entity may execute a set of instructions to control the functional elements of the wireless UE or the wireless network entity to perform the described functions. Additionally, or alternatively, the wireless UE or the wireless network entity may perform aspects of the described functions using special-purpose hardware.

At 1205, the method may include generating a set of shaping bits based on performing a constellation shaping operation on a set of information bits. The operations of 1205 may be performed in accordance with examples as disclosed herein. In some examples, aspects of the operations of 1205 may be performed by a constellation shaping component 825 as described with reference to FIG. 8.

At 1210, the method may include performing, based on the set of shaping bits, a first error correction encoding operation according to a first coding rate to generate a first set of coded bits. The operations of 1210 may be performed in accordance with examples as disclosed herein. In some examples, aspects of the operations of 1210 may be performed by a first EC component 830 as described with reference to FIG. 8.

At 1215, the method may include performing, based on the set of information bits, a second error correction encoding operation according to a second coding rate to generate a second set of coded bits. The operations of 1215 may be performed in accordance with examples as disclosed herein. In some examples, aspects of the operations of 1215 may be performed by a second EC component 835 as described with reference to FIG. 8.

At 1220, the method may include transmitting at least one control message indicating a resource allocation and an offset that identifies a first resource mapping within the resource allocation for the first set of coded bits and a second resource mapping within the resource allocation for the second set of coded bits, the offset corresponding to the first coding rate and the second coding rate. The operations of 1220 may be performed in accordance with examples as disclosed herein. In some examples, aspects of the operations of 1220 may be performed by a RE mapping component 840 as described with reference to FIG. 8.

At 1225, the method may include mapping the first set of coded bits to a first set of consecutive REs according to the first resource mapping and the second set of coded bits to a second set of consecutive REs different from the first set of consecutive REs according to the second resource mapping, where the resource allocation includes the first set of consecutive REs and the second set of consecutive REs. The operations of 1225 may be performed in accordance with examples as disclosed herein. In some examples, aspects of the operations of 1225 may be performed by a RE mapping component 840 as described with reference to FIG. 8.

At 1230, the method may include transmitting, via the resource allocation, the first set of coded bits in accordance with the first resource mapping and the second set of coded bits in accordance with the second resource mapping based on the at least one control message. The operations of 1230 may be performed in accordance with examples as disclosed herein. In some examples, aspects of the operations of 1230 may be performed by a data transceiver 845 as described with reference to FIG. 8.

FIG. 13 shows a flowchart illustrating a method 1300 that supports encoding schemes for wireless communications systems that support constellation shaping in accordance with aspects of the present disclosure. The operations of the method 1300 may be implemented by a UE or a network entity or its components as described herein. For example, the operations of the method 1300 may be performed by a UE 115 or a network entity as described with reference to FIGS. 1 through 10. In some examples, a UE or a network entity may execute a set of instructions to control the functional elements of the wireless UE or the wireless network entity to perform the described functions. Additionally, or alternatively, the wireless UE or the wireless network entity may perform aspects of the described functions using special-purpose hardware.

At 1305, the method may include receiving at least one control message indicating a resource allocation and an offset that identifies a first resource mapping within the resource allocation for a first set of coded bits and a second resource mapping within the resource allocation for a second set of coded bits, the offset corresponding to a first coding rate associated with the first set of coded bits and a second coding rate associated with the second set of coded bits. The operations of 1305 may be performed in accordance with examples as disclosed herein. In some examples, aspects of the operations of 1305 may be performed by a RE mapping component 840 as described with reference to FIG. 8.

At 1310, the method may include receiving, via the resource allocation, the first set of coded bits in accordance with the first resource mapping and the second set of coded bits in accordance with the second resource mapping based on the at least one control message. The operations of 1310 may be performed in accordance with examples as disclosed herein. In some examples, aspects of the operations of 1310 may be performed by a data transceiver 845 as described with reference to FIG. 8.

At 1315, the method may include performing, based on the first set of coded bits, a first error correction decoding operation to generate a set of shaping bits. The operations of 1315 may be performed in accordance with examples as disclosed herein. In some examples, aspects of the operations of 1315 may be performed by a first EC component 830 as described with reference to FIG. 8.

At 1320, the method may include performing, based on the second set of coded bits, a second error correction decoding operation to generate a set of decoded bits. The operations of 1320 may be performed in accordance with examples as disclosed herein. In some examples, aspects of the operations of 1320 may be performed by a second EC component 835 as described with reference to FIG. 8.

At 1325, the method may include generating, based on the set of decoded bits and the set of shaping bits and using a constellation deshaping operation, a set of information bits. The operations of 1325 may be performed in accordance with examples as disclosed herein. In some examples, aspects of the operations of 1325 may be performed by a constellation shaping component 825 as described with reference to FIG. 8.

FIG. 14 shows a flowchart illustrating a method 1400 that supports encoding schemes for wireless communications systems that support constellation shaping in accordance with aspects of the present disclosure. The operations of the method 1400 may be implemented by a UE or a network entity or its components as described herein. For example, the operations of the method 1400 may be performed by a UE 115 or a network entity as described with reference to FIGS. 1 through 10. In some examples, a UE or a network entity may execute a set of instructions to control the functional elements of the wireless UE or the wireless network entity to perform the described functions. Additionally, or alternatively, the wireless UE or the wireless network entity may perform aspects of the described functions using special-purpose hardware.

At 1405, the method may include receiving at least one control message indicating a resource allocation and an offset that identifies a first resource mapping within the resource allocation for a first set of coded bits and a second resource mapping within the resource allocation for a second set of coded bits, the offset corresponding to a first coding rate associated with the first set of coded bits and a second coding rate associated with the second set of coded bits. The operations of 1405 may be performed in accordance with examples as disclosed herein. In some examples, aspects of the operations of 1405 may be performed by a RE mapping component 840 as described with reference to FIG. 8.

At 1410, the method may include receiving the first set of coded bits using a first set of consecutive REs according to the first resource mapping. The operations of 1410 may be performed in accordance with examples as disclosed herein. In some examples, aspects of the operations of 1410 may be performed by a data transceiver 845 as described with reference to FIG. 8.

At 1415, the method may include receiving the second set of coded bits using a second set of consecutive REs different than the first set of consecutive REs according to the second resource mapping, where the resource allocation includes the first set of consecutive REs and the second set of consecutive REs. The operations of 1415 may be performed in accordance with examples as disclosed herein. In some examples, aspects of the operations of 1415 may be performed by a data transceiver 845 as described with reference to FIG. 8.

At 1420, the method may include performing, based on the first set of coded bits, a first error correction decoding operation to generate a set of shaping bits. The operations of 1420 may be performed in accordance with examples as disclosed herein. In some examples, aspects of the operations of 1420 may be performed by a first EC component 830 as described with reference to FIG. 8.

At 1425, the method may include performing, based on the second set of coded bits, a second error correction decoding operation to generate a set of decoded bits. The operations of 1425 may be performed in accordance with examples as disclosed herein. In some examples, aspects of the operations of 1425 may be performed by a second EC component 835 as described with reference to FIG. 8.

At 1430, the method may include generating, based on the set of decoded bits and the set of shaping bits and using a constellation deshaping operation, a set of information bits. The operations of 1430 may be performed in accordance with examples as disclosed herein. In some examples, aspects of the operations of 1430 may be performed by a constellation shaping component 825 as described with reference to FIG. 8.

The following provides an overview of aspects of the present disclosure:

Aspect 1: A method for wireless communication at a wireless device, comprising: generating a set of shaping bits based at least in part on performing a constellation shaping operation on a set of information bits; performing, based at least in part on the set of shaping bits, a first ECE operation according to a first coding rate to generate a first set of coded bits; performing, based at least in part on the set of information bits, a second ECE operation according to a second coding rate to generate a second set of coded bits; transmitting at least one control message indicating a resource allocation and an offset that identifies a first resource mapping within the resource allocation for the first set of coded bits and a second resource mapping within the resource allocation for the second set of coded bits, the offset corresponding to the first coding rate and the second coding rate; and transmitting, via the resource allocation, the first set of coded bits in accordance with the first resource mapping and the second set of coded bits in accordance with the second resource mapping based at least in part on the at least one control message.

Aspect 2: The method of aspect 1, wherein transmitting the at least one control message comprises: transmitting a first control message indicating the offset; and transmitting a second control message indicating the resource allocation.

Aspect 3: The method of any of aspects 1 through 2, wherein transmitting the at least one control message comprises: transmitting a first control message indicating a MCS table, wherein the MCS table comprises an indication of a plurality of coding rates associated with the set of shaping bits; and transmitting a second control message comprising an index to the MCS table that identifies a third coding rate of the plurality of coding rates that is applied during the constellation shaping operation.

Aspect 4: The method of any of aspects 1 through 3, further comprising: mapping the first set of coded bits to a first set of consecutive REs according to the first resource mapping and the second set of coded bits to a second set of consecutive REs different from the first set of consecutive REs according to the second resource mapping, wherein the resource allocation comprises the first set of consecutive REs and the second set of consecutive REs.

Aspect 5: The method of aspect 4, wherein mapping the first set of coded bits and the second set of coded bits comprises: mapping the first set of coded bits to the first set of consecutive REs using a frequency-first, time-second mapping scheme; and mapping, after mapping the first set of coded bits, the second set of coded bits to the second set of consecutive REs using the frequency-first, time-second mapping scheme.

Aspect 6: The method of any of aspects 4 through 5, wherein transmitting the first set of coded bits and the second set of coded bits comprises: transmitting the first set of coded bits using the first set of consecutive REs; and transmitting the second set of coded bits using the second set of consecutive REs.

Aspect 7: The method of any of aspects 1 through 6, wherein the offset identifies a relationship between the first coding rate and the second coding rate.

Aspect 8: The method of any of aspects 1 through 7, further comprising: modulating the first set of coded bits using a first modulation scheme; and modulating the second set of coded bits using a second modulation scheme, wherein a modulation order associated with the first modulation scheme is smaller than a modulation order associated with the second modulation scheme.

Aspect 9: The method of any of aspects 1 through 8, wherein performing the constellation shaping operation comprises: inputting the set of information bits to a block decoder to generate the set of shaping bits; inputting the set of shaping bits into a block encoder to generate a set of output bits; and applying a Boolean function to the set of information bits and the set of output bits to generate a third set of bits, wherein the second set of coded bits are generated based at least in part on performing the second ECE operation to the third set of bits according to the second coding rate.

Aspect 10: The method of aspect 9, wherein a code type associated with the block encoder or the block decoder comprises polar code, Hamming code, BCH code, Reed-Solomon code, or LDPC code.

Aspect 11: The method of any of aspects 1 through 10, further comprising: inputting the set of shaping bits into a CRC encoder to generate a set of CRC bits, wherein the first set of coded bits comprises the set of CRC bits.

Aspect 12: The method of any of aspects 1 through 11, further comprising: receiving a feedback message indicating whether one or both of the first set of coded bits or the second set of coded bits were decoded successfully.

Aspect 13: The method of any of aspects 1 through 12, wherein transmitting the at least one control message comprises: transmitting a RRC message, DCI, a MAC-CE, or a combination thereof, wherein the RRC message, the DCI, or the MAC-CE indicates one or both of the resource allocation or the offset.

Aspect 14: The method of any of aspects 1 through 13, wherein a code type associated with the first ECE operation is different than a code type associated with the second ECE operation.

Aspect 15: The method of aspect 14, wherein the code type associated with the first ECE operation comprises polar code and the code type associated with the second ECE operation comprises LDPC code.

Aspect 16: A method for wireless communication at a wireless device, comprising: receiving at least one control message indicating a resource allocation and an offset that identifies a first resource mapping within the resource allocation for a first set of coded bits and a second resource mapping within the resource allocation for a second set of coded bits, the offset corresponding to a first coding rate associated with the first set of coded bits and a second coding rate associated with the second set of coded bits; receiving, via the resource allocation, the first set of coded bits in accordance with the first resource mapping and the second set of coded bits in accordance with the second resource mapping based at least in part on the at least one control message; performing, based at least in part on the first set of coded bits, a first ECD operation to generate a set of shaping bits; performing, based at least in part on the second set of coded bits, a second ECD operation to generate a set of decoded bits; and generating, based at least in part on the set of decoded bits and the set of shaping bits and using a constellation deshaping operation, a set of information bits.

Aspect 17: The method of aspect 16, wherein receiving the at least one control message comprises: receiving a first control message indicating the offset; and receiving a second control message indicating the resource allocation.

Aspect 18: The method of any of aspects 16 through 17, wherein receiving the at least one control message comprises: receiving a RRC message, DCI, a MAC-CE, or a combination thereof, wherein the RRC message, the DCI, or the MAC-CE indicates one or both of the resource allocation or the offset.

Aspect 19: The method of any of aspects 16 through 18, wherein receiving the first set of coded bits and the second set of coded bits comprises: receiving the first set of coded bits using a first set of consecutive REs according to the first resource mapping; and receiving the second set of coded bits using a second set of consecutive REs different than the first set of consecutive REs according to the second resource mapping, wherein the resource allocation comprises the first set of consecutive REs and the second set of consecutive REs.

Aspect 20: The method of aspect 19, further comprising: determining a number of REs included in the first set of consecutive REs based at least in part on the offset.

Aspect 21: The method of any of aspects 16 through 20, wherein receiving the at least one control message comprises: receiving a first control message indicating a MCS table, wherein the MCS table comprises an indication of a plurality of coding rates associated with the set of shaping bits; and receiving a second control message comprising an index to the MCS table that identifies a third coding rate of the plurality of coding rates that is applied during a constellation shaping operation.

Aspect 22: The method of any of aspects 16 through 21, further comprising: demodulating the first set of coded bits using a first modulation scheme; and demodulating the second set of coded bits using a second modulation scheme, wherein a modulation order associated with the first modulation scheme is smaller than a modulation order associated with the second modulation scheme.

Aspect 23: The method of any of aspects 16 through 22, wherein performing the constellation deshaping operation comprises: inputting the set of shaping bits into a block encoder to generate a set of output bits; and applying a Boolean function to the set of decoded bits and the set of output bits to generate the set of information bits.

Aspect 24: The method of aspect 23, wherein a code type associated with the block encoder comprises polar code, hamming code, BCH code, Reed-Solomon code, or LDPC code.

Aspect 25: The method of any of aspects 16 through 24, wherein the first set of coded bits comprises a set of cyclic redundancy bits, the method further comprising: generating, based at least in part on the first set of coded bits, the set of shaping bits using a CRC decoder.

Aspect 26: The method of any of aspects 16 through 25, further comprising: transmitting a feedback message indicating whether one or both of the first set of coded bits or the second set of coded bits were decoded successfully.

Aspect 27: The method of any of aspects 16 through 26, wherein the offset identifies a relationship between the first coding rate and the second coding rate.

Aspect 28: The method of any of aspects 16 through 27, wherein a code type associated with the first ECD operation is different than a code type associated with the second ECD operation.

Aspect 29: The method of aspect 28, wherein the code type associated with the first ECD operation comprises polar code and the code type associated with the second ECD operation comprises LDPC code.

Aspect 30: An apparatus for wireless communication at a wireless device, comprising a processor; memory coupled with the processor; and instructions stored in the memory and executable by the processor to cause the apparatus to perform a method of any of aspects 1 through 15.

Aspect 31: An apparatus for wireless communication at a wireless device, comprising at least one means for performing a method of any of aspects 1 through 15.

Aspect 32: A non-transitory computer-readable medium storing code for wireless communication at a wireless device, the code comprising instructions executable by a processor to perform a method of any of aspects 1 through 15.

Aspect 33: An apparatus for wireless communication at a wireless device, comprising a processor; memory coupled with the processor; and instructions stored in the memory and executable by the processor to cause the apparatus to perform a method of any of aspects 16 through 29.

Aspect 34: An apparatus for wireless communication at a wireless device, comprising at least one means for performing a method of any of aspects 16 through 29.

Aspect 35: A non-transitory computer-readable medium storing code for wireless communication at a wireless device, the code comprising instructions executable by a processor to perform a method of any of aspects 16 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a wireless device, comprising:
a processor;
memory coupled with the processor; and
instructions stored in the memory and executable by the processor to cause the apparatus to:
generate a set of shaping bits based at least in part on performing a constellation shaping operation on a set of information bits;
perform, based at least in part on the set of shaping bits, a first error correction encoding operation according to a first coding rate to generate a first set of coded bits;
perform, based at least in part on the set of information bits, a second error correction encoding operation according to a second coding rate to generate a second set of coded bits;
transmit at least one control message indicating a resource allocation and an offset that identifies a first resource mapping within the resource allocation for the first set of coded bits and a second resource mapping within the resource allocation for the second set of coded bits, the offset corresponding to the first coding rate and the second coding rate; and
transmit, via the resource allocation, the first set of coded bits in accordance with the first resource mapping and the second set of coded bits in accordance with the second resource mapping based at least in part on the at least one control message.

2. The apparatus of claim 1, wherein the instructions to transmit the at least one control message are executable by the processor to cause the apparatus to:
transmit a first control message indicating the offset; and
transmit a second control message indicating the resource allocation.

3. The apparatus of claim 1, wherein the instructions to transmit the at least one control message are executable by the processor to cause the apparatus to:
transmit a first control message indicating a modulation and coding scheme table, wherein the modulation and coding scheme table comprises an indication of a plurality of coding rates associated with the set of shaping bits; and
transmit a second control message comprising an index to the modulation and coding scheme table that identifies a third coding rate of the plurality of coding rates that is applied during the constellation shaping operation.

4. The apparatus of claim 1, wherein the instructions are further executable by the processor to cause the apparatus to:
map the first set of coded bits to a first set of consecutive resource elements according to the first resource mapping and the second set of coded bits to a second set of consecutive resource elements different from the first set of consecutive resource elements according to the second resource mapping, wherein the resource allocation comprises the first set of consecutive resource elements and the second set of consecutive resource elements.

5. The apparatus of claim 4, wherein the instructions to map the first set of coded bits and the second set of coded bits are executable by the processor to cause the apparatus to:
map the first set of coded bits to the first set of consecutive resource elements using a frequency-first, time-second mapping scheme; and
mapping, after map the first set of coded bits, the second set of coded bits to the second set of consecutive resource elements using the frequency-first, time-second mapping scheme.

6. The apparatus of claim 4, wherein the instructions to transmit the first set of coded bits and the second set of coded bits are executable by the processor to cause the apparatus to:
transmit the first set of coded bits using the first set of consecutive resource elements; and
transmit the second set of coded bits using the second set of consecutive resource elements.

7. The apparatus of claim 1, wherein the offset identifies a relationship between the first coding rate and the second coding rate.

8. The apparatus of claim 1, wherein the instructions are further executable by the processor to cause the apparatus to:
modulate the first set of coded bits using a first modulation scheme; and
modulate the second set of coded bits using a second modulation scheme, wherein a modulation order associated with the first modulation scheme is smaller than a modulation order associated with the second modulation scheme.

9. The apparatus of claim 1, wherein the instructions to perform the constellation shaping operation are executable by the processor to cause the apparatus to:
input the set of information bits to a block decoder to generate the set of shaping bits;
input the set of shaping bits into a block encoder to generate a set of output bits; and
apply a Boolean function to the set of information bits and the set of output bits to generate a third set of bits, wherein the second set of coded bits are generated based at least in part on performing the second error correction encoding operation to the third set of bits according to the second coding rate.

10. The apparatus of claim 9, wherein a code type associated with the block encoder or the block decoder comprises polar code, Hamming code, Bose-Chaudhuri-Hocquenghem code, Reed-Solomon code, or low density parity check code.

11. The apparatus of claim 1, wherein the instructions are further executable by the processor to cause the apparatus to:
input the set of shaping bits into a cyclic redundancy check encoder to generate a set of cyclic redundancy check bits, wherein the first set of coded bits comprises the set of cyclic redundancy check bits.

12. The apparatus of claim 1, wherein the instructions are further executable by the processor to cause the apparatus to:
receive a feedback message indicating whether one or both of the first set of coded bits or the second set of coded bits were decoded successfully.

13. The apparatus of claim 1, wherein the instructions to transmit the at least one control message are executable by the processor to cause the apparatus to:
transmit a radio resource control message, downlink control information, a medium access control control element, or a combination thereof, wherein the radio resource control message, the downlink control information, or the medium access control control element indicates one or both of the resource allocation or the offset.

14. The apparatus of claim 1, wherein a code type associated with the first error correction encoding operation is different than a code type associated with the second error correction encoding operation.

15. The apparatus of claim 14, wherein the code type associated with the first error correction encoding operation comprises polar code and the code type associated with the second error correction encoding operation comprises low density parity check code.

16. An apparatus for wireless communication at a wireless device, comprising:
a processor;
memory coupled with the processor; and
instructions stored in the memory and executable by the processor to cause the apparatus to:
receive at least one control message indicating a resource allocation and an offset that identifies a first resource mapping within the resource allocation for a first set of coded bits and a second resource mapping within the resource allocation for a second set of coded bits, the offset corresponding to a first coding rate associated with the first set of coded bits and a second coding rate associated with the second set of coded bits;
receive, via the resource allocation, the first set of coded bits in accordance with the first resource mapping and the second set of coded bits in accordance with the second resource mapping based at least in part on the at least one control message;
perform, based at least in part on the first set of coded bits, a first error correction decoding operation to generate a set of shaping bits;
perform, based at least in part on the second set of coded bits, a second error correction decoding operation to generate a set of decoded bits; and
generate, based at least in part on the set of decoded bits and the set of shaping bits and using a constellation deshaping operation, a set of information bits.

17. The apparatus of claim 16, wherein the instructions to receive the at least one control message are executable by the processor to cause the apparatus to:
receive a first control message indicating the offset; and
receive a second control message indicating the resource allocation.

18. The apparatus of claim 16, wherein the instructions to receive the at least one control message are executable by the processor to cause the apparatus to:
receive a radio resource control message, downlink control information, a medium access control control element, or a combination thereof, wherein the radio resource control message, the downlink control information, or the medium access control control element indicates one or both of the resource allocation or the offset.

19. The apparatus of claim 16, wherein the instructions to receive the first set of coded bits and the second set of coded bits are executable by the processor to cause the apparatus to:
receive the first set of coded bits using a first set of consecutive resource elements according to the first resource mapping; and
receive the second set of coded bits using a second set of consecutive resource elements different than the first set of consecutive resource elements according to the second resource mapping, wherein the resource allocation comprises the first set of consecutive resource elements and the second set of consecutive resource elements.

20-26. (canceled)

27. A method for wireless communication at a wireless device, comprising:
generating a set of shaping bits based at least in part on performing a constellation shaping operation on a set of information bits;
performing, based at least in part on the set of shaping bits, a first error correction encoding operation according to a first coding rate to generate a first set of coded bits;
performing, based at least in part on the set of information bits, a second error correction encoding operation according to a second coding rate to generate a second set of coded bits;
transmitting at least one control message indicating a resource allocation and an offset that identifies a first resource mapping within the resource allocation for the first set of coded bits and a second resource mapping within the resource allocation for the second set of coded bits, the offset corresponding to the first coding rate and the second coding rate; and
transmitting, via the resource allocation, the first set of coded bits in accordance with the first resource mapping and the second set of coded bits in accordance with the second resource mapping based at least in part on the at least one control message.

28-30. (canceled)
